(19) United States
(12) Patent Application Publication
(10) Pub. No.: US 2015/0069254 A1
(43) Pub. Date: Mar. 12, 2015

(54) SAMPLE ANALYZING SYSTEM

(71) Applicant: Georgia Tech Research Corporation, Atlanta, GA (US)

(72) Inventors: Facundo M. Fernandez, Atlanta, GA (US); Joel David Keelor, Atlanta, GA (US)

(21) Appl. No.: 14/541,595

(22) Filed: Nov. 14, 2014

Related U.S. Application Data
(63) Continuation of application No. PCT/US2013/041730, filed on May 17, 2013.
(60) Provisional application No. 61/648,268, filed on May 17, 2012.

(51) Int. Cl. G01N 27/62; H01J 49/16; H01J 49/06; H01J 49/26; H01J 49/02

(52) U.S. Cl. CPC G01N 27/622; H01J 49/26; H01J 49/025; H01J 49/062; H01J 49/16
USPC 250/389

(57) ABSTRACT

A system, method and apparatus for injecting reactive species and ions from an ambient ionization source into an atmospheric pressure ion mobility spectrometer

### CROSS-REFERENCE TO RELATED APPLICATIONS

This application is a continuation of International Application No. PCT/US2013/041730, filed 17 May 2013, which claims the benefit of U.S. Provisional Application No. 61/648,268, filed 17 May 2012, both herein fully incorporated by reference.

### BACKGROUND OF THE INVENTION

1. Field of the Invention

The present invention is directed towards a sample analyzing system, and more particularly to a system, method and apparatus for injecting reactive species and ions from an ambient ionization source into an atmospheric pressure ion mobility spectrometer.

2. Description of the Related Art

In order to address current and future chemical vapor and aerosol threats to homeland security, chemical detection systems should be versatile and robust to identify hazardous chemicals ranging from traditional chemical warfare agents (CWA) to toxic industrial compounds (TIC). Instruments should operate in an efficient, easy, and safe manner so that trained users can obtain reliable and reproducible readings. Instruments should be flexible to meet changing homeland security goals for chemical analysis, and in particular, have the ability to be portable aiding first responders with the identification of any unknown toxins in the event of a serious industrial accident exposing workers to TICs or public exposure to CWAs from a terrorist attack.

Detection technologies including chemical sensor arrays, electrophoresis-based lab-on-a-chip devices, impedance measurements with modified carbon nanotubes, piezoresistive microcantilevers, and micro gas analyzers have been shown to be potential fieldable technologies capable of chemical agent detection.

Solid phase microextraction (SPME) coupled to gas chromatography (GC), fast GC, and liquid chromatography (LC) are also common approaches to detection of CWAs and TICs in both laboratory and field environments.

Additionally, low ppb detection limits and rapid response of ion mobility spectrometry (IMS) has been shown to be a very useful tool for the detection of CWAs and TICs. Thousands of portable IMS units have been distributed throughout the world associated with aviation security against explosives and battlefield detection of CWAs.

IMS instruments often use a radioactive ionization source (e.g. ⁶³Ni) emitting β-electrons due to its simplicity and reliable performance. However, procedural requirements involving the licensing, placement, use, and disposal of these instruments incur additional costs and regulations. Electrospray, corona and glow discharges, laser, X-ray, and photo ionization techniques are other common ionization techniques used for IMS.

The emergence of new ambient ionization techniques has led to an explosive growth in new applications and methodologies for mass spectrometry (MS) experiments, including analytical instrumental techniques widely used for chemical analysis of a variety of samples in the fields of industrial manufacturing (chemical, textile, semiconductor etc.), energy plants (oil, gas, biofuel, solar, electrochemical, and nuclear), medicine, agriculture, archeology, food safety, pharmaceutical analysis, law enforcement, homeland security, doping control, airport safety, space exploration, environmental monitoring, forensics, laboratory research, etc. Largely absent from these advances has been the coupling of ambient ionization techniques to IMS. To date, only the ambient ionization technique desorption electrospray ionization (DESI) has been coupled to reduced pressure IMS for the analysis of pharmaceuticals, peptides, and proteins. One of the primary reasons for this is the difficultly in transporting ambiently-generated ions against an uphill electric field at the entrance of an atmospheric pressure (AP) IMS instrument. Utilization of reduced pressure of ion traps, funnels, or optics to pump ions into the instrument before entering an IM cell within the instrument has been examined.

As discussed, atmospheric pressure IMS is a widely used analytical detection tool for ionized compounds. Fundamentally, IMS is a gas-phase electrophoretic separation where ions are pulsed into the drift or “separation” tube against a counter flow of a neutral drift gas. Separation of the analyte ion packet is dictated by differences in the ions' mass, charge, and cross-section before detection. This rapid detection is on the millisecond timescale which makes IMS a very attractive high-throughput tool for analyte detection. Commercial sales of IMS target usage in national security and military applications where it has been shown to be effective in the detection of narcotics, explosives, chemical warfare agents and other hazardous or toxic chemicals.

Traditionally, the ionization source for IMS has been a radioactive-emitter foil which produces high energy electrons that result in sample ionization. Although the amount of radioactive material is fairly small, special storage, training, compliance and safety procedures must be followed when using this set-up to prevent radioactive contamination of the operator, and to maintain the traceability of the radioactive material. Additionally, the amount of charge available from radioactive foils used in IMS for sample ionization is limited, resulting in lower sensitivity and marked competition effects. For these reasons, replacing radioactive ionizers with more efficient and less dangerous approaches is highly desirable. Another deficient aspect of radioactive ionizers is that they require gaseous samples for operation, implying that liquids have to be vaporized before interrogation and solids have to be grinded and dissolved. Forced liquid volatilization can degrade the sample, hindering correct identification and detection. Spray, UV and laser-based ionizers used as alternative to radioactive ionizers often require high voltages, elaborate setups, potentially harmful radiation, accurate alignment, etc. to ensure efficient ion production. As a result, such approaches are usually only implemented in research settings.

US Patent Publications 2008/0173809 to Wu, 2005/0205775 to Bromberg et al., 2008/0121797 to Wu, and U.S. Pat. No. 5,192,865 to Zhu are known. US Patent Publication 2008/0173809 to Wu discloses that simply placing a plasma ion source in front of the inlet to the ion mobility instrument will be sufficient for efficient ion transmission into the instrument and subsequent ion mobility analysis. However, as one of skill in the art understands, this will only work under two conditions: 1) if the gas velocity flux leaving the ion source is greater than the magnitude of the upfront electric field present at the entrance of the instrument; and/or 2) the ion source is held at a higher floating potential than the entrance electrode of the ion mobility instrument. With one or both of these operating principles, it would be theoretically possible to ionize and effectively transport ions from outside of the entrance electrode of the ion mobility spectrometer to inside it for separation.

Bromberg et al. uses a plasma based ionization technique for ion mobility spectrometry (IMS). Particular mention in Bromberg et al. is spent on the separate placement of an electron beam source, such as a corona discharge, from within the instrument. A window, such as made from diamond or sapphire, allows the electron current to pass into an enclosure region where the sample is held to promote ionization and reduce negative space charging effects.

US Patent Publication No. 2008/0121797 to Wu discloses the use of a sampling substrate, such as a porous media. In 2008/0121797 to Wu, a vapor preconcentrator is used to concentrate desorbed species, which can then be rereleased into an extraction zone for ionization.

Zhu outlines the use of an atmospheric pressure afterglow discharge source coupled to a charged ion detector. However, the implementation as outlined in Zhu focuses on nebulized samples and a solvent return system for sampling in the afterglow region of the source. As outlined in Zhu sampling intact samples could not be possible without interference of the plasma-flux stability since ion/electron charge densities would be in a state of constant flux. Further, the afterglow plasma ion source of Zhu cannot be implemented outside a standalone ion mobility spectrometer since the electric field bias on the ion source would need to be higher than the entrance electrode on the ion mobility spectrometer.

Thus, a need exists for direct ionization techniques, in particular those employing electric plasmas such as Direct Analysis in Real Time (DART), and its coupling to ion mobility spectrometry (IMS) for the improved analysis of solids, liquids and gases directly, without sample preparation. Such an approach should be applicable to other detection methods such as IMS-mass spectrometry (IMS-MS) and simple mass spectrometry (MS).

### BRIEF SUMMARY OF THE INVENTION

The present invention comprises a system that marries open-air plasma ionization techniques, commonly called ambient plasma ionization techniques, in particular, metastable and reactive species generating ambient ionization techniques such as, among others, Direct Analysis in Real Time (DART), Flowing Atmospheric Pressure Afterglow (FAPA), and Low Temperature Plasma probe (LTP) to ion mobility spectrometry (IMS).

In a preferred embodiment, the present invention comprises a new ion injection scheme incorporating a repeller point electrode used to shape the electric field, facilitating ion transmission from a DART ion source. The electrode can be made of many emissive metal or even a non-metallic conductors, and of many shapes and sizes. Single or multiple metal needles, wires, prongs, sheets, or meshes are but a few of the forms that the electrode can take.

In an exemplary embodiment, the sample analyzing system comprises an ionization source configured to ionize a sample under ambient pressure, the ionization source having an activated ionization source potential, an ion detector configured to operate under ambient pressure, the ion detector having an inlet with an activated ion detector inlet potential greater than the activated ionization source potential, the activated ionization source potential and the activated ion detector inlet potential formed when, respectively, the ionization source and the ion detector are activated, and a repeller positioned at the inlet of the ion detector and biased above the activated ion detector inlet potential to guide at least a portion of the ions from the ionization source into the ion detector.

The ionization source can be, for example, a plasma ionization source, a direct analysis in real time (DART) ionization source, a desorption electrospray ionization (DESI) source, a desorption atmospheric pressure photoionization (DAPPI) source, and an electrospray-assisted laser desorption/ionization (ELDI) source, among others.

The repeller can be an electrode. The repeller potential can be greater than or equal to 1 kV over activated ion detector inlet potential.

The ionization source can be positioned orthogonally to the ion detector inlet, and the repeller can be coaxially centered normal to the ion detector inlet.

The invention can analyze solids, liquids and gases.

In another exemplary embodiment, the present invention a comprises a method of analyzing a sample comprising ionizing at least a portion of surface bound species of a sample under ambient pressure, guiding at least a portion of the ions toward ion detector configured to operate under ambient pressure, the ion detector having an inlet with an activated ion detector inlet potential that must be overcome to enable at least a majority of guided ions to enter the inlet, and biasing at least a portion of the guided ions into the inlet of the ion detector by providing a biasing potential in proximity of the inlet that is greater than the activated ion detector inlet potential.

Drift tube ion mobility (IM) spectrometry is a robust analytical platform routinely used to provide rapid separation and identification of compounds based on their size/charge ratio. Most modern atmospheric pressure IM detectors require corona discharge and electrospray ion sources for efficient ionization. Meanwhile, coupling DTIMS with new generation ambient plasma-based discharge techniques has proven an exceptional challenge. Device sensitivity with ambient sources is hindered by poor ion transmission at the source-instrument interface due to ion repulsion by the high electric field.

To overcome this shortfall, the present invention can comprise an ion mobility spectrometer constructed from monolithic resistive glass. A desolvation cell (12 cm) and drift region (26 cm) can be separated by a Bradbury-Nielsen style ion gate. Potential can be applied to the IMS by a HV power supply connected through a voltage divider. Signal can be collected by a Faraday plate detector and custom amplifier.

Ion gate timing can be provided via software control using, for example, a NI 5111 pulse generator synchronized with data acquisition on a NI 6111 A/DC and Labview 7.1. A DART ion source preferably is positioned orthogonally at the IMS inlet facing a repeller point electrode oriented coaxial to the IMS opening.

System characterization performed for different source component configurations and operational parameters, including repeller electrode potential and position inside of the IMS, both DART and repeller angles relative to the IMS inlet, and sample position exterior to the IMS provide interesting results. Signal was only observed when the repeller electrode was elevated ≧1 kV above the IMS entrance.

Maximum sensitivity was achieved with the repeller electrode arranged coaxially. Signal intensity and stability for the standard IMS calibrant 2,6-DtBP was observed to improve with increasing repeller electrode potential and depth inside the IMS. At higher DART angles approaching the repeller (coaxial) or repeller angles approaching the DART capillary (orthogonal), signal rapidly decreased to baseline as ion transmission became erratic from repulsive e-field effects.

Source capability for solids analysis when paired with DTIMS was also evaluated for a series of standard and counterfeit antimalarial tablets and over-the-counter pharmaceuticals. Sensitivity depended strongly on sample position relative to the DART and IMS entrance, as well as the thermal desorption limits of the DART source. Reproducible signal was consistently observed for tablets containing acetaminophen and dihydroartemisinin with lower spectral complexity and greater sensitivity than corona discharge.

The present invention is likely translatable to other ambient ion sources, affording analysis of solids using DTIMS without protracted sample preparation.

In another exemplary embodiment, the present invention allows direct sampling of solids and liquids, and improves overall sensitivity, via a plasma ionizer (an example of which is DART, but could also be applied to a corona ionizer, LTP, FAPA, DBDI etc.) coupled with a point-shaped repeller electrode for efficient electric field focusing. The gas outlet of the plasma ionizer is modified to incorporate a metastable gas transfer tube which may simultaneously serve as a support for the sample introduction system. Metastable gas flowing from this transfer tube reacts with the sample and atmospheric gases producing ions. The transfer tube is optimally made of a chemically inert material (e.g. glass) that will not ionize due to collisions with the metastable and other reactive species formed by the ionization source. This tube may be thermally resistive (e.g. ceramic) or externally heated to maintain the reactive gas temperature of the species exiting the heated region of the ionization source. This tube may also be electrically conductive (e.g. stainless steel or resistive glass) to extract ions from the metastable reactive stream before contacting the sample and to produce a secondary higher electrical field in addition to the electrical field generated from the plasma ionizer and IMS.

The gas transfer tube focuses the reactive gas plume onto the sample, facilitating efficient ionization of surface bound species by mechanisms such as protonation, deprotonation, chemical sputtering or surface ionization (e.g. surface Penning-ionization). In addition, the reactive gas stream and/or the IMS instrument may be heated to facilitate thermal desorption of neutral analytes from the sample matrix. Desorbed analytes are then be ionized by the reactive gas plume that exits the gas transfer line via chemical ionization pathways (e.g. Penning, charge-exchange, and proton-transfer pathways). Once ions from the sample are created, the specific shape of the electric field formed by the point-shaped repeller placed facing the detector (IMS, IMS-MS or MS) entrance guides the ions towards the IMS ion molecule reaction cell. An electrical potential is applied to the repeller. This potential is higher than that at the entrance of the detector. The potential can be applied in a pulsed fashion, raising it from a value lower than that at the entrance of the IMS to a value that is higher, or simply kept constant, maintaining a net potential difference with the inlet which ensures ion transmission. The constant potential approach is simpler in terms of implementation.

The important geometric variables to adjust for optimal configuration have been identified. The starting arrangement is very sensitive regarding the position of the repeller relative to the metastable plasma stream emanating from the transfer tube. Reactant ion signal is only observed if the plasma gas is fired directly on the tip of the repeller electrode, and not millimeters in front or behind.

The reactant ion peak (RIP) spectrum for repeller-DART appears similar to corona ionizer RIP, but slightly less complex. As expected, signal intensity decreases as the distance of the repeller electrode distance from the IMS entrance increases. The shape of electrical field determined by the point-to-IMS orifice is critical, and is predicted to be best defined when coaxially aligned with the IMS opening.

The system is less sensitive to the angle of the DART source, as long as the metastable plasma flow is focused on the repeller tip. The starting configuration keeps the plasma ionizer outlet orthogonal to the repeller in an effort to reduce turbulence at the IMS inlet caused by directly opposing drift tube and DART gas streams. Data collected using this technique for the direct analysis of drug tablets has been promising. Sample signal has best been observed positioning the solid tablet between the DART stream and repeller tip. Higher plasma gas temperatures (400° C.) and flow rates (2.5 L min-1 N₂) facilitate analyte desorption from the tablets. Ionization efficiency is strongly influenced by the manner in which tablet shape affects the fluid dynamics around the repeller in this arrangement. Other repeller-plasma outlet configurations for samples are being investigated.

In another preferred embodiment, the present invention comprises a system using direct in-situ ionization within the electric field gradient of a drift tube (DT) atmospheric pressure IMS instrument to enhance sensitivity, improve ion transport, and provide a safe sampling strategy. In exemplary embodiments, a direct analysis in real time (DART) ionization source is used for this coupling due to its generation of uncharged but highly energetic metastable species which could be injected directly into an electric field where the sample is placed.

DART, FAPA, LTP, and other ambient plasma ionization techniques have attracted significant attention due to their high-throughput analysis capabilities and straightforward operation. When coupled to mass spectrometry (MS) ambient plasma ionization generated ions can be mass analyzed for identification. Unfortunately, field portable mass spectrometers are still in the initial stages of development, whereas atmospheric pressure drift tube ion mobility spectrometry (DTIMS) has been successfully deployed in a wide variety of field scenarios.

In atmospheric pressure DTIMS ions are separated according to their ionic mobility in a time-invariant electric field while drifting against a flow of drift gas. An ambient plasma-based ionization atmospheric pressure DTIMS platform offers an easy-to-use, low maintenance chemical agent monitoring system that could also be applied to other fields, including food safety, pharmaceutical cleaning validation, and any scenarios requiring high throughput chemical analysis.

The present invention can comprise a sample analyzing system including a plasma ionization source configured to ionize an analyte sample under ambient pressure, an ion mobility spectrometer configured to operate under ambient pressure, wherein the ion mobility spectrometer comprises an inlet, an ionization region, a ion separation region, and some type of detector, arranged such that the ionization region is downstream of the inlet, the ion separation region is downstream of the ionization region, and the detector is downstream of the ion separation region, and a sample transport assembly configured to transport the analyte sample through the inlet of the ion mobility spectrometer and to the ionization region, wherein the sample transport assembly is in physical communication with the plasma ionization source, wherein the analyte sample is ionized in the ionization region of the ion mobility spectrometer, and wherein an electric field at the inlet of the ion mobility spectrometer is greater than an electric field produced by the plasma ionization source when both the ion mobility spectrometer and the plasma ionization source are activated.

The sample transport assembly can comprise a sample platform configured to hold the analyte sample, and a tube comprising a first end comprising an inlet and a second end comprising an outlet, wherein the first end of the tube is in physical communication with the plasma ionization source, and wherein the second end of the tube is in physical communication with the sample platform.

The sample platform can be porous, beneficially facilitating transport of a liquid, gaseous, or aerosol analyte sample into the ionization region of the ion mobility spectrometer.

The porous sample platform can comprise a sorbent material for holding the liquid, gaseous, or aerosol analyte sample, and can be at least partially formed from an electrically conductive material.

The at least partially electrically conductive porous sample platform can be positioned at the inlet or within the ionization region of the ion mobility spectrometer effective to permit the electric field of the ion mobility spectrometer to travel through the electrically conductive porous sample platform such that the inlet comprises at least a portion of the ionization region.

In another exemplary embodiment of the present invention, a method of analyzing a sample is disclosed, the method comprising providing an ion mobility spectrometer comprising an inlet, an ionization region, a ion separation region, and a detector, arranged such that the ionization region is downstream of the inlet, the ion separation region is downstream of the ionization region, and the detector is downstream of the ion separation region, introducing an analyte sample into the ionizing region of the ion mobility spectrometer, ionizing the analyte sample within the ionizing region of the ion mobility spectrometer, wherein the ionization occurs under ambient pressure via a plasma ionization source, separating ions of the ionized analyte sample under ambient pressure within the ion separation region, and detecting at least a portion of the ions under ambient pressure with the detector of the ion mobility spectrometer, wherein an electric field at the inlet of the ion mobility spectrometer is greater than an electric field produced by the plasma ionization source when both the ion mobility spectrometer and the plasma ionization source are activated, and wherein both the plasma ionization source and the ion mobility spectrometer are not activated when the analyte sample is introduced into the ionizing region of the ion mobility spectrometer.

The sample introduction step can be accomplished using a sample transport assembly, wherein the sample transport assembly is in physical communication with the plasma ionization source.

The analyte sample can comprise more than one chemical constituent, such that ionizing the analyte sample comprises ionizing each of the more than one chemical constituents separating ions of the ionized analyte sample comprises separating ions of each of the more than one chemical constituents, and detecting at least the portion of the ions comprises detecting at least a portion of the ions of each of the more than one ionized chemical constituents.

Each of the more than one chemical constituents can be ionized simultaneously or in a time-resolved fashion.

The at least a portion each of the more than one ionized chemical constituents can be detected at a different time.

In another exemplary embodiment, the present invention comprises an ambient analyte identification process comprising providing an ion mobility spectrometer with an inlet and a reaction region in a drift tube, applying an electric field at the inlet of the ion mobility spectrometer, placing a sample through the inlet, and into the reaction region of the ion mobility spectrometer, and ionizing the sample in the reaction region of the ion mobility spectrometer with an ambient plasma ionization source, wherein the ions travel through the drift tube which has the applied electric field and a carrier buffer gas that opposes the ions' motion, and wherein a detector in proximity to a distal end of the drift tube can distinguish different analyte species based on an ions' mass, charge, size and shape, such that the migration time through the tube is characteristic of different ions.

Ionization of the sample can occur in-situ within the electric field gradient of the ion mobility spectrometer. Ionization of the sample can provided by an ambient plasma ionization source. The drift tube can comprises monolithic resistive glass.

Placing a sample through the inlet, and into the reaction region of the ion mobility spectrometer can comprise mounting the sample and a reagent gas transfer tube on a movement system, wherein the reagent gas transfer tube both holds the sample, and hydro-dynamically focuses the gas plume from the ambient plasma ionization source onto the sample, facilitating efficient ionization of surface bound species.

The movement system can comprise a rail system external the ion mobility spectrometer allowing for safe, repeatable and reproducible placement of the sample into the reaction region of the ion mobility spectrometer.

In another exemplary embodiment, the present invention comprises a sample analysis system comprising an ambient plasma ionization source, an ion mobility spectrometer located distal the ambient plasma ionization source, the ion mobility spectrometer having an inlet and a reaction region, and an ambient transport assembly to transfer ions from the ambient plasma ionization source to the reaction region of the ion mobility spectrometer.

In another exemplary embodiment, the present invention comprises a method of sample analysis comprising generating ions with an ion generator at a first electric potential, injecting the ions from the ion generator into the ion measurement device, and identifying the ions with an ion measurement device at a second electric potential, wherein the first electric potential is lower than the second electric potential, and wherein since the first electric potential is lower than the second electric potential, injecting the ions from the ion generator to the ion measurement device occurs.

An object of the present invention is to provide a system, method and apparatus for injecting reactive species and analyte ions from an ambient ion source into an IMS. This embodiment is exemplified with a plasma-based ambient ion source where ions are to be injected from a low or null electrical field region into a high field region such as generation of ions by an ionization technique at a lower electric potential than the instrument.

Another object of the present invention is to provide a system, method and apparatus that can directly sample solids, liquids and gases/aerosols within the high electric field region of the IMS (in-situ ion generation) or of an externally-generated electrical field outside of the opening entrance of the IMS extending as far away as the ambient ionization source.

The present invention provides ways of interfacing an ambient plasma based ionization technique such as direct analysis in real time mass spectrometry (DART) with an ion mobility spectrometer/separator. The present invention demonstrates and details the precise coupling of a plasma ion source such as DART to an ion mobility instrument.

The present invention is patentably distinct from US Patent Publication 2008/0173809 to Wu at least as to alternative methods to circumvent excessive gas flow rates and/or electric fields. For example, the present invention maintains the normal operating conditions of the ionization source (gas flow rates <6 L/min, discharge V_{dc}<5 kV) so that typical home-built and commercial ionization sources can be interfaced to ion mobility instruments with little to no modification. This is done by, for example, passively ionizing samples in-situ (within) the instrument itself in a desolvation/reactive drift tube prior to the ion gating mechanism, such as a Bradbury-Nielsen ion gate/shutter, providing the advantage of not needing to modify the ion source settings. This is demonstrated by an extended gas nozzle that goes from the plasma ion source exit to the entrance electrode and in some cases inside the reactive drift tube of the ion mobility instrument itself. This approach can be accomplished with the electric field of the ion source and ion mobility instrument on or off.

In another embodiment of the present invention, a plasma induced secondary emission ionization (PISI) ion source can be used to eliminate the Bradbury Nielsen gate. When used in combination with an IMS or IMS-MS instrument, the pulsing of ions by the use of the metal electrode can replace the ion-gate typically needed in IMS. Creation of ion packets by pulsing the potential on the metal electrode of the PISI source is also possible. Essentially, the repeller could be pulsed to inject ions and the Bradbury Nielsen gate eliminated.

With the PISI ion source, a metallic sample could be machined into the necessary shape to act as the electrode to study its chemical properties or the standard electrode could be coated with new materials to study the properties. Enhancement in sensitivity and selectivity for the detection of ion(s) of interest can be effected by coating the metal surface of the PISI electrode with specific chemicals or by using a hollow electrode to introduce chemical dopants and modifiers into the ionization region of the instrument.

The present invention also demonstrates a transmission-mode geometry in which an extended gas nozzle is not required, but can still be used such that the sample is deposited on a conductive perforated material, such as a steel mesh, which is held at a potential higher or at the same as the entrance electrode bias of the ion mobility instrument. Since ionization occurs at the origin of the applied electrical field, this can again be classified as in-situ ionization, but different from the above method in that the sample is positioned farther away from the ion gate by not being within the reactive drift tube. Both approaches utilize uncharged energetic metastable species produced by the plasma ion source and not ions produced by the plasma ion source. Therefore, the metastables can travel into the ion mobility instrument without high gas velocity or electric field assistance as required in an implementation outlined in US Patent Publication 2008/0173809 to Wu.

Unlike Bromberg et al., the present invention preferably filters out any of the primary charged particles (electrons, ions) produced by the plasma ion source utilizing only neutral gas molecules and neutral metastable species. These chemical species are neither composed in an accelerated beam nor a pulsed beam as described in Bromberg et al. They are simply emitted from the plasma ion source and can be hydrodynamically focused with gas nozzles of varying geometries. Sampling with the present invention is enclosureless in both the passive and transmission-mode geometries, unlike Bromberg et al. Ions formed in the present invention do not need to be preconcentrated as shown in Bromberg et al. Additionally, timing of the ion shutter grid is independent of both the applied ion mobility and ion source voltages, unlike Bromberg et al.

The present invention is patentably distinct from US Patent Publication No. 2008/0121797 to Wu in that an applied voltage is placed on the sample holder and/or transmission-material to improve ion dynamic focusing and transport. In 2008/0121797 to Wu, it is never specified or implied that the sample substrate is in contact with gas originating from a plasma ionization source, such as the gas jet exiting an ambient plasma source. Additionally, the present invention does not require a chemical coating. The nature of coating used in the present invention is an inert derivative of graphitized black, which is not disclosed in 2008/0121797 to Wu.

Additionally, unlike 2008/0121797 to Wu, the present system allows for both passive offline analysis of gases, liquids, aerosols, suspensions and powders to be collected and tested or the direct application of similar samples to the transmission material without the use of artificial purging of gases into the preconcentration region. Direct application can be accomplished via automated, robotic, human or other manual supervised or unsupervised method.

The transmission material and substrate of the present system allows for heating via heated gas, contact with the heated ion mobility instrument and direct application of a current to a conductive transmission material. No additional sample ports for ion sources are required for interfacing to other ionization sources since the present invention is standalone. Further, the sample holder is not sealed in the present implementation and is inert, free from chemical modification. It is used only to hold a preferred sample like a solid or a transmission material such as a screen mesh.

Unlike Zhu, a present method removes the implementation of plasma ionization sources, in particular ambient sources, with a charged ion detector (in one case, an ion mobility spectrometer), and therefore, it can sample solids and liquids via neutral sputtering or thermal desorption. As discussed, Zhu cannot sample intact samples without interference of the plasma-flux stability since ion/electron charge densities would be in a state of constant flux. The present invention can remove such effects by utilizing ionization processes via the interaction of neutral metastable species directly with the samples and/or interaction of neutrals via Penning ionization with other species that can then ionize the sample. Further, unlike Zhu, the plasma source of the present invention can be operated at any conditions away or connected to the instrument by using the disclosed method for coupling and injection of metastable species to and within the entrance of the ion mobility instrument where the intact sample is placed for in-situ analysis.

Other aspects and features of embodiments of the present invention will become apparent to those of ordinary skill in the art, upon reviewing the following detailed description in conjunction with the accompanying figures.

### BRIEF DESCRIPTION OF THE FIGURES

The various embodiments of the invention can be better understood with reference to the following drawings. The components in the drawings are not necessarily to scale, emphasis instead being placed upon clearly illustrating the principles of the various embodiments of the present invention. In the drawings, like reference numerals designate corresponding parts throughout the several views.

FIG. 1 illustrates a cross-sectional view of the DART-IMS interface according to an exemplary embodiment of the present invention.

FIGS. 2a-2b are a top and side view, respectively, of a sampling tube with sample holder collar according to an exemplary embodiment of the present invention.

FIGS. 3a-3b are a front view a sorbent screen mesh assembly, and its location in the setup, respectively, according to an exemplary embodiment of the present invention.

FIG. 4 is a graph of the temperature gradient at the tip of the sample capillary, according to an exemplary embodiment of the present invention.

FIG. 5 is a graph of intensity versus drift time during an analysis of an exemplary embodiment of the present invention.

FIGS. 6a-6d are graphs of intensity versus drift time during an analysis of an exemplary embodiment of the present invention.

FIGS. 7a-7c are graphs of intensity versus drift time during an analysis of an exemplary embodiment of the present invention.

FIG. 8 is a graph of the mean, median, lower, upper and interquartiles of each analyte tested plotted in a box plot, according to an exemplary embodiment of the present invention.

FIGS. 9a-9d illustrate multiplexing with IMS, according to an exemplary embodiment of the present invention.

FIGS. 10a-10f are graphs of intensity versus drift time during an analysis of an exemplary embodiment of the present invention.

FIGS. 11a-11f are graphs of intensity versus drift time during an analysis of an exemplary embodiment of the present invention.

FIGS. 12a-12b are graphs of multiplexed gains of the 200 and 400 μs gates for all sweep averages over conventional mode, according to an exemplary embodiment of the present invention.

FIGS. 13a-13f are graphs of intensity versus drift time during an analysis of an exemplary embodiment of the present invention.

FIG. 14 is a schematic of resistive glass DTIMS interface showing the starting configuration for the repeller electrode and DART-SVP ion source. The repeller potential and position, and the DART and repeller angles were varied as depicted during characterization studies.

FIG. 15 shows the signal for acetaminophen tablet as a function of repeller electrode potential at a fixed depth (7 mm). The repeller was centered coaxially and normal to the IMS entrance, held at 12,000 V with drift N₂ at 1 L/min. The DART was oriented orthogonal to the repeller at the plane of the IMS face with N₂ flow 2.5 L/min. A) Repeller potential at 13,500 V with DART (300° C.) discharge off. B) Repeller potential at 13,500 V with DART (300° C.) discharge on. C) Repeller potential at 14,500 V with DART (300° C.) discharge on. D) Repeller potential at 14,500 V with DART (300° C.) discharge off. E) Repeller potential at 14,500 V with DART (450° C.) discharge off. F) Repeller potential at 14, 500 V with DART (450° C.) discharge on.

FIG. 16 is a DART generated signal for 2,6-DtBP vapor as a function of the repeller depth inside the IMS inlet for increasing electrode potentials. The repeller was centered coaxially and normal to the IMS entrance with the DART capillary resting orthogonal to the repeller at the plane of the IMS face.

FIG. 17 is a DART generated signal for 2,6-DtBP vapor at DART angles between 0 and 60 degrees from orthogonal) the repeller centered and coaxial) the repeller coaxial and offset 6 mm from the DART capillary) the repeller centered and coaxial with the rod shielded. The repeller was fixed at 7 mm inside the IMS opening and the DART capillary exit was spaced ˜1 cm from the center of the IMS entrance across all angles. Repeller potential was 13,300 kV.

FIG. 18 shows the signal for 2,6-DtBP vapor with coaxial repeller angles ranging between 60 and 120 degrees from orthogonal (90° center and normal to IMS entrance) for DART and corona only regimes. The electrode point was fixed at 7 mm inside the IMS and rotated on axis, keeping the tip stationary. The DART capillary was kept orthogonal (0°) at the IMS face.

FIG. 19 is a Simion 8.1 scale model showing the potential energy lines (left) and potential energy contour (right) for the first 1.5 cm of the IMS inlet at 12,000 V with and without the repeller electrode (13,500 V).

### DETAILED DESCRIPTION OF PREFERRED EMBODIMENTS

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

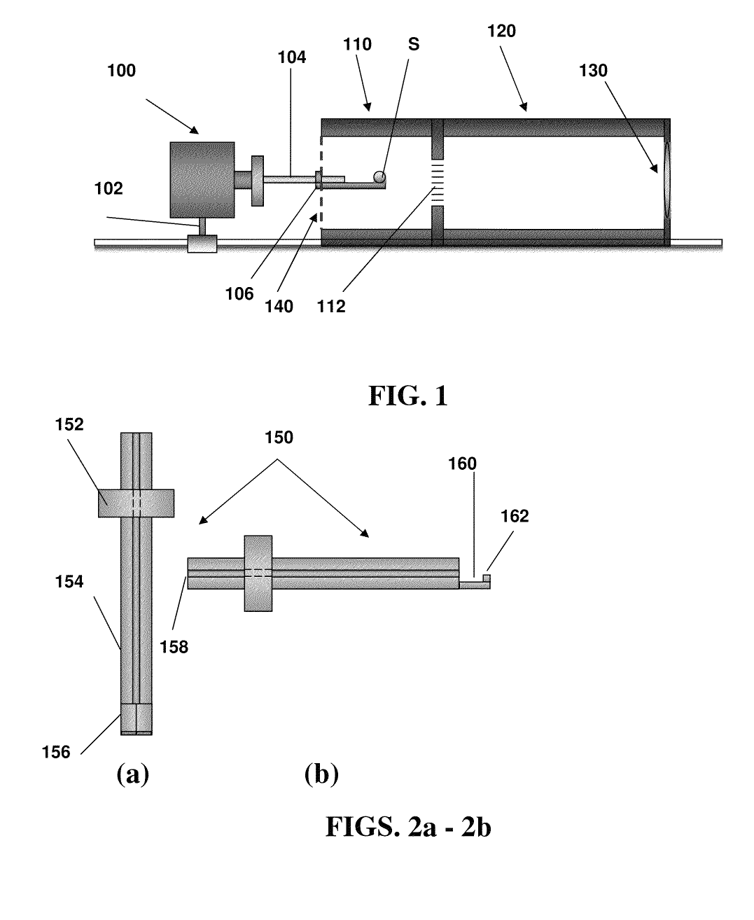

FIG. 1 illustrates cross-sectional depiction of the DART-IMS interface of a preferred embodiment of the present invention. The interface comprises a DART or other plasma type ion source 100, height and longitudinal adjustable rail 102, hydrodynamic gas transfer tube 104, sample holder with rotational and longitudinal adjustable collar 106 IMS reaction chamber 110 (high voltage), sample S (solid tablet shown here), pulsed ion gate 112, IMS drift tube 120 (high voltage), ion detector 130 (low voltage), and a perforated grid to enhance ion transmission 140.

A conventional DART-type ion source 100 can modified by coupling a reactive gas transfer tube 104 to the ion source gas outlet that extends into the high electrical field. The reagent gas transfer tube 104 can simultaneously serve as a support for the sample S. The transfer tube 104 is optimally made of a chemically inert material (e.g. glass) that will not ionize due to collisions with the metastable and other reactive species formed by the ionization source. This tube 104 may be thermally resistive (e.g. ceramic) or externally heated to maintain the reactive gas temperature of the species exiting the heated region of the ionization source. Tube 104 may also be electrically conductive (e.g. stainless steel or resistive glass) to extract ions from the metastable reactive stream before contacting the sample and to produce a secondary higher electrical field in addition to the electrical field generated from the DART and IMS.

The gas transfer tube 104 focuses the reactive gas plume onto the sample S, facilitating efficient ionization of surface bound species by mechanisms such as chemical sputtering or surface ionization (e.g. surface Penning-ionization). In addition, the reactive gas stream and/or the IMS instrument may be heated to facilitate thermal desorption of neutral analytes from the sample matrix. Desorbed analytes would then be ionized by the reactive gas plume that exits the gas transfer line via chemical ionization pathways (e.g. Penning, charge-exchange, and proton-transfer pathways).

Mounting the ion source and the transfer tube on a moveable rail system 102 external to the ion mobility instrument allows the assembly to be reproducibly inserted into and out of the IMS drift tube high electric field. For improved ion transmission, an electrically-conductive grid 112 can be either (a) mounted on the sample holder so it electrically contacts the spectrometer inlet when the sample is placed in position, or (b) furnished with a small perforation and mounted directly on the IM spectrometer entrance so the transfer tube can slide through it when inserted.

The sampling tube 104 can be furnished with the sample holder collar 106 that can be custom built for solids (as shown in FIGS. 2a and 2b) or be as simple as a holder for supporting melting point glass capillaries for liquids. A combined DART-IMS custom transfer tube/sample holder 150 can comprise an adjustable (rotational and transverse) collar 152, a non conductive gas tube support sleeve 154, a sample stage 156, gas transfer tube inlet 158, a gas transfer tube outlet 160, and a sample support lip 162.

This sample holder/sampling tube assembly 150 facilitates precise sample placement within the drift tube maximizing detection sensitivity and reproducibility. Gas/aerosol samples may be analyzed by pumping or directing the gas such that it interacts with the reactive gas exiting into the instrument or by collection onto appropriate grids mounted on the above described interface.

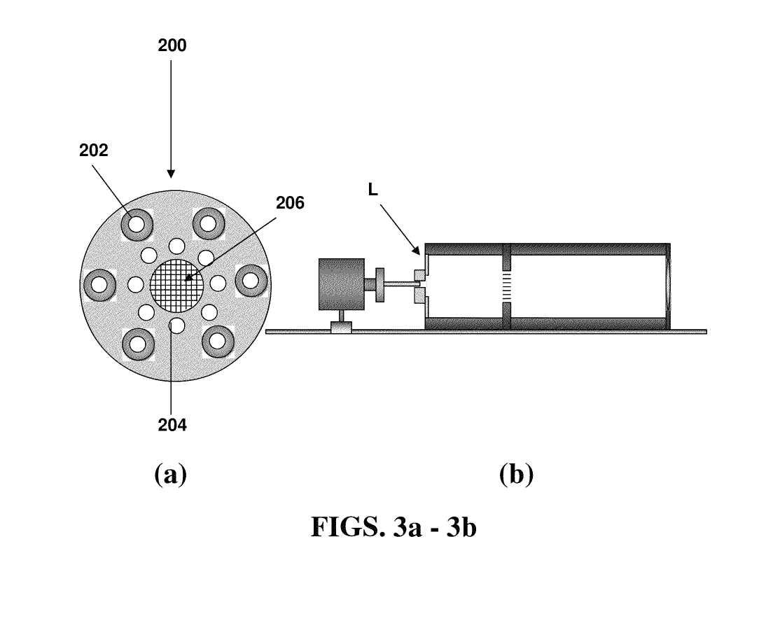

Liquids and gases/aerosols may be extracted and/or preconcentrated onto premade porous materials, screens, meshes or fibers with a sorbent coating removing the need of external gas pumping into the instrument and improving sensitivity (FIG. 3). The sorbent screen mesh or fiber holder assembly 200 can connect to the front of the IMS via screws 202 for easy removal, and can include vent holes 204 to allow gas to leave the instrument, while the sorbent material 206 is placed in the middle of the assembly 200 to allow for transmission-mode analysis. Location L illustrates the screen-supporting assembly 200 mounted on the IM spectrometer.

Sorbent screens, meshes and fibers can be mounted internally of the instrument in much the same way as solids. If the sorbent materials are mounted external to the instrument they are positioned directly in front of the reactive gas stream in a “transmission-mode” geometry with a custom sample holder to mount to any IMS. With a transmission-mode orientation the reactive gas stream will pass through the analyte embedded material to allow for ionization of the absorbed material without major disruptions in the gas flow. If the sorbent substrate (mesh or fiber) are electrical conductors (e.g. metal) an electrical potential may be applied to them to allow for ions to be directed into the drift tube of the IMS. In this case, a separate electrical grid at the entrance may be avoided. This electrical potential may be higher or the same as the potential at the entrance of the IMS to facilitate the best electrical field for sampling.

The present set-up allows for ion losses to be minimized by forming analyte ions in-situ within an electrical field generated solely or in part by the IMS, mitigating ion-ion recombination, minimizing neutralization of ions upon formation within the drift tube, and maximizing ion trajectories toward the IMS gate and drift tube.

Safety is improved by placing the sampling system on a moveable assembly that can enter and exit the instrument for tuning, cleaning, and sample placement away from the high field regions when not in operation. These simple assemblies can take many forms, but can implement moveable rails, tracks, bearings, and collars which can easily slide. After securing the sample to the sample holder, the moveable assembly is introduced into the instrument. Depending on the implementation, the electrical fields can be held constantly on, or rapidly turned on after an optional safety interlock is engaged when actuating the rail system.

Thus, the present invention combines the advantages of atmospheric pressure drift tube ion mobility spectrometry with ambient ionization. The present invention eliminates the requirements of a vacuum, utilizes relatively low power, avoids solvents, and provides controlled ionization. It can analyze samples of any shape and size directly, and is adaptable to vapors, liquids, and solids depending on need (i.e. a “platform”).

The present invention can be implemented together with multiplexing approaches for trace analysis when using various discharge gases such as, among others, helium, nitrogen, argon, and air.

In an exemplary embodiment, a DART is being coupled to a non-traditional IMS design that has at least two inventive features: it is fabricated with two sections of resistive Pb-silicate glass (“glass tubes”) H₂-reduced to have a given electrical resistance, and it allows for operation in the “pulse-wait” mode (such as a TOF), or in a more sensitive “multiplexed” mode, where more ions are injected. An advantage of using resistive glass is that the design is safer (no need for exposed high voltage dividers), machining cost is much reduced (no stainless steel to machine), and the instrument is greatly simplified. The system incorporates many beneficial parameters for optimization: ion injection geometry, drift voltage, reaction chamber voltage, DART gas and IMS drift gas flow (magnitudes and directions), gas and chamber temperatures.

In an exemplary method of operation, the sample is introduced as a solid (attached to the end of sampling probe shown next), liquid (continuously through a tube that runs parallel to sampling probe or directly applied to the probe), or as a gas (via a miniature pump or headspace sampling system that feeds into the end of the sampling probe). Ions are generated continuously as sample is supplied, or as a broad pulse if a finite amount of sample is ionized. The ions travel towards an ion gating system (e.g., among others, interleaved set of alternating polarity 20 μm wires, and pulsed electrode). This gate opens and closes for μs injections at a frequency of several Hz. Each one of the μs pulses is the start of a “sweep”. Multiple sweeps can be averaged. The ions produced by the plasma source are separated in drift chamber against a countercurrent of gas.

### Experiments

### Reagents

All reagents were analytical grade, purchased from the same chemical supplier (Sigma-Aldrich, St. Louis, Mo., USA) and used without further purification. Solutions of dimethyl methylphosphonate (DMMP, 97%), 2-Chloroethyl ethyl sulfide (2-CEES, 98%), 2,4-Lutidine (99%), and 2,6-Di-tert-butylpyridine (2,6-DtBP, ≧97%) were prepared in pure nanopure water (Barnstead International, Dubuque, Iowa, USA), and methamidophos (≧98%) was prepared in a 50% methanol solution. Concentrations of the solutions are described below but for the initial studies 10% solutions of 2,4-lutidine and 2,6-DtBP in H₂O were used. DART and IMS gas was high purity N₂ (99.995% Airgas, Atlanta, Ga.).

Instrumentation

A resistive glass drift tube ion mobility spectrometer was used. The desolvation (12 cm) and drift (26 cm) regions (3 cm i.d., 4 cm o.d.) were constructed out of monolithic resistive glass (PHOTONIS USA, Sturbridge, Mass.) at a 0.45 GΩcm⁻¹ resistance. A Bradbury-Nielsen-type ion gate was placed between the two drift tubes. When closed, the ion gate applied ±35 V to adjacent wire sets. The drift tubes were wrapped with silicone heating tape (Minco, Minneapolis, Minn.). The tubes were supported in a custom made PEEK mounting assembly. This assembly was mounted within a protective Faraday cage for safe operation and for electromagnetic insulation against interferences. Two grid electrodes were used in this set-up. One was positioned in front of the iridited aluminum plate (2.6 cm diameter) Faraday plate detector (TOFWERK AG, Thun, Switzerland). The other grid electrode was placed at the entrance of the desolation tube and had a 0.5 cm slit in the middle for the DART glass gas tube to pass through (described below). A high-voltage power supply (FUG HCL 14-2000, Magnavolt Technologies, Plattsburgh, N.Y.) was connected to a voltage divider to supply the potentials for the entrances, exits, ion gate and grid electrodes. Drift gas entered the instrument behind the detector plate and was controlled by a precision flow meter (PMR1, Bel-ART/Scienceware, Pequannock, N.J.). Data acquisition and ion gate timing was controlled by in-house developed software coded in LabView 7.0 (National Instruments, Austin, Tex.).

A DART-SVP ionization source (IonSense, Inc. Saugus, Mass., USA) was used for all experiments. The ion source was operated in positive ion mode. The DART gas nozzle was connected to a 15 cm long glass tube (0.15 cm i.d., 0.3 cm o.d.). The glass tube was used to inject nitrogen metastable species directly into the desolvation tube. A melting point glass capillary tube where liquid samples were deposited was affixed to the glass tube extending 2 cm past the exit. This entire assembly was easily pulled into and out of the desolvation tube through the open slit on the grid electrode due to the built in rail assembly of the ion source.

Set-Up And Procedure

IMS settings for most experiments were as follows: entrance grid and entrance of desolvation tube 12,000 V, 400 μs gate pulse widths, 200 μs data acquisition bins, 400 spectral sweeps averaged per analysis, 150° C. instrument temperature, N₂ drift gas at 1 L min⁻¹. Each 400 μs gate pulse comprised an element in a n=256 element sequence. For the multiplexing experiments, both 200 μs and 400 μs digital (n=512 and 256, respectively) and Hadamard (n=511 and 255, respectively) gating sequences were used, and were accompanied with a constant 50 μs data acquisition bin. DART settings for all experiments were as follows: positive mode glow discharge, grid voltage +500 V, 2.5 L min⁻¹ N₂ flow rate, and 400° C. heater temperature.

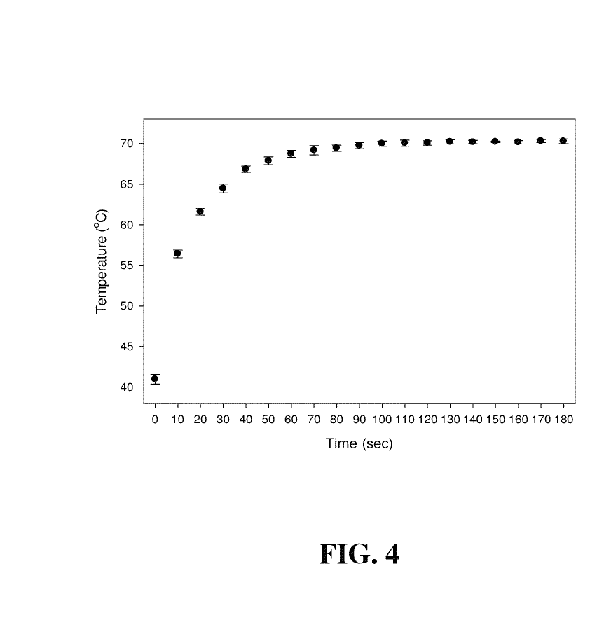

With the DART source set to stand-by, 2 μL of the liquid samples were deposited on the melting point capillaries with the sampling assembly pulled out of the IMS. As soon as the liquid was deposited, the sample assembly was moved into the IMS desolvation tube such that the gas transfer tube from the DART source extended 1.5 cm inside, and therefore the tip of the melting point capillary was 3.5 cm inside. The DART source was turned on and the data acquisition started. An 80 BK temperature probe connected to a multimeter (Fluke 179-True RMS, Everett, Wash.) was used to measure the temperature gradient at the tip of the sample capillary (FIG. 4). When the sample is placed inside the desolvation tube and the DART source is turned on, there is a steep rise in the measured temperature up to 60 sec. From 60 sec until the end of the data acquisition (180 sec), the temperature remains fairly steady between 68.7 to 70.2° C.

Sequential data acquisitions were saved to monitor the detection response with respect to time for three minutes. For instance, a data file with the first 400 spectral sweeps took approximately 41 seconds to acquire. After the computer averages and saves this file (19 seconds) the next acquisition window started. Acquisition was repeated once more for a total of 3 averaged runs taking 1 minute each (3 minutes total). The same procedure was performed for the multiplexing experiments which investigated shorter averaging windows corresponding to the experiment performed for a more direct comparison with the conventional gating sequences. For all experiments, solvent blanks were run before each replicate to ensure a baseline signal was present. No reactive ion peaks were detected during blank or experimental runs.

Results and Discussion

With standalone IMS detection, the reduced mobility (K₀, in units of cm²V⁻¹s⁻¹) values can be calculated to help with identification of the ion species (Eq. 1):

$${K}_{0} = \frac{d}{Et} \frac{P}{760} \frac{273}{T} \qquad ( Eq . 1 )$$

where d is the distance the ion drifts from the gate to the detector, t is the drift time of the ion, E is the electric field strength, P is the ambient pressure, and T is the drift tube temperature. The validity in these values is strengthened by MS detection for mass identification and reduced mobility tables have been constructed for various analytes although one single database has not been developed. It is possible that reported reduced mobility values may be wrong and thereby, incorrectly identify ions that are not mass analyzed. Errors can be due to several factors such as impurities, cluster formations, and/or thermal expansion or contraction of the drift tube, amongst others.

If a mass analyzer is not installed for IMS/MS detection, standard compounds with well investigated and stable reduced mobility values can be used to determine the reduced mobilities of unknowns under identical experimental conditions (Eq. 2):

$${K}_{0} ( unknown ) = \frac{{K}_{0} ( standard ) {t}_{d} ( standard )}{{t}_{d} ( unknown )} \qquad ( Eq . 2 )$$

Although there is not one definitive IMS standard, experiments using 2,6-DtBP have shown the molecule to be reliable since it gives a single, stable protonated molecule signal under various experimental conditions with K₀=1.42 cm²V⁻¹s⁻¹. Using 2,6-DtBP standard in the present system allowed for identification of the types of species formed during DART-IMS experiments.

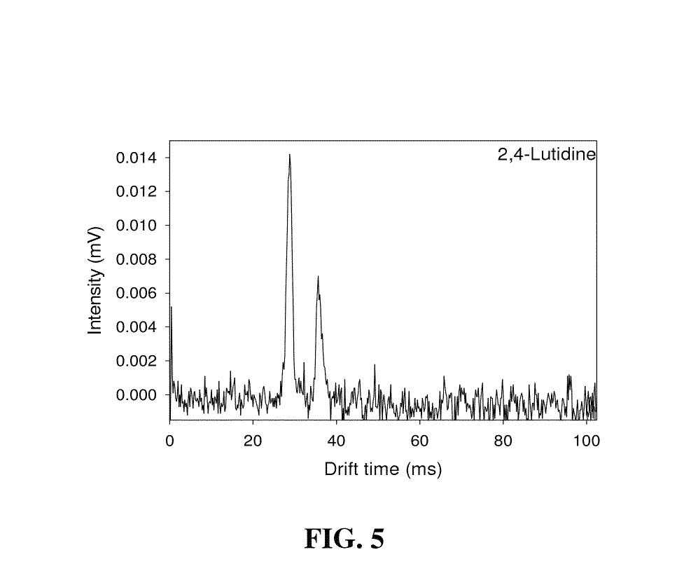

Initially, 2,4-lutidine was analyzed to assess the ion species formed during DART-IMS. At a field strength of 381.9 V cm⁻¹, two peaks were observed (FIG. 5). The two peaks at t_{d}=28.8 and 35.6 ms had K₀=1.73 and 1.40 cm²V⁻¹s⁻¹, respectively. Literature values for the protonated molecule and dimer of 2,4-lutidine are 1.95 and 1.43 cm²V⁻¹s⁻¹, respectively. There is good correlation that the second peak is the protonated dimer of 2,4-lutidine, but the first observed peak has a reduced mobility value indicative of an ion size larger than the protonated molecule but smaller than the dimer. The first peak is likely a [M+H]⁺(H₂O)ₙ product ion of 2,4-lutidine. This cluster species has previously been observed with atmospheric pressure IMS. The protonated molecule cluster was probably formed from a reaction similar to Kebarle's water displacement mechanism (Eq. 3a) and the dimer was formed from subsequent reactions between these cluster species and neutrals (Eq: 3b):

$$\begin{matrix}{( {H}_{2} O )}_{n} {H}^{+} ( g ) + M ( g ) \to {M ( {H}_{2} O )}_{n} {H}^{+} ( g ) & ( Eq . 3 a ) \\ M ( g ) + {M ( {H}_{2} O )}_{n} {H}^{+} ( g ) {\to }^{heat} {( 2 M + H )}^{+} ( g ) + {( {H}_{2} O )}_{n} & ( Eq . 3 b )\end{matrix}$$

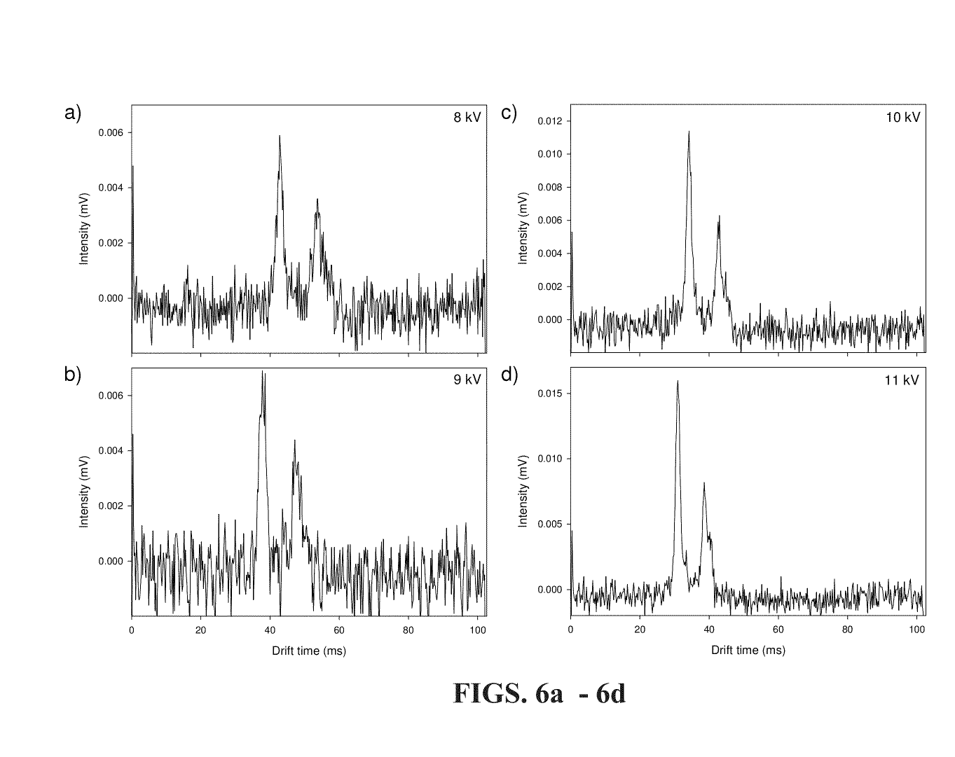

Additional experiments at other field strengths of 255, 286.5, 318.1, and 349.6 V cm⁻¹ showed the same species were formed indicating the generation of protonated clusters and dimers is likely occurring during ionization, and not from reactions during the ion drift time. (FIGS. 6a-6d).

In the lab, dimer formation of acetaminophen has been observed with DART analysis and other pharmaceuticals for identification of unknown active ingredients. Furthermore, cluster formation of atmospheric water vapor is always observed in the background of DART-MS experiments formed from Penning ionization, and solvent clusters have been suggested as having significant roles in ion formation via a transient microenvironment concept. Without declustering during travel within the first differentially-pumped stage of the mass spectrometer, cluster ions are likely to remain intact in DART-IMS.

The DART-IMS system was tested as a potential chemical agent monitoring system by monitoring three different toxic analytes: DMMP (Chemical Weapons Convention Schedule 2 substance used in the synthesis of Sarin) and 2-CEES (mustard gas analog) are both chemical warfare simulants, and a low vapor pressure chemical methamidophos (a harmful pesticide). The threshold of probable detection (TPD) of each analyte was assessed by monitoring its detection at five different concentration levels in replicates (n=8). The amount of successful detections (response SNR≧3) was fitted to a logistic function defined by (Eq. 4):

$$y = \frac{{A}_{1} - {A}_{2}}{1 + {( x / {x}_{o} )}^{p}} + {A}_{2} \qquad ( Eq . 4 )$$

where, A₁ and A₂ are the lower and upper asymptote values, respectively, x₀ is the point of inflection and p is the rate of the curve steepness. The TPD is then selected at the point on the curve where the likelihood of detection is at least 95% (the level at which there is less than a 5% false negative rate). The TPD for DMMP, 2-CEES, and methamidophos were 11.81%, 1.13%, and 10.61 mM, respectively. These levels are high considering fmol solution concentrations using nanoESI-IMS have been performed on this instrument, and ppm and ppb levels are routinely detected with other IMS systems. Most likely, the relatively low temperatures and slow desorption time of the analytes from solution is the predominant cause. Work is underway to improve this problem.

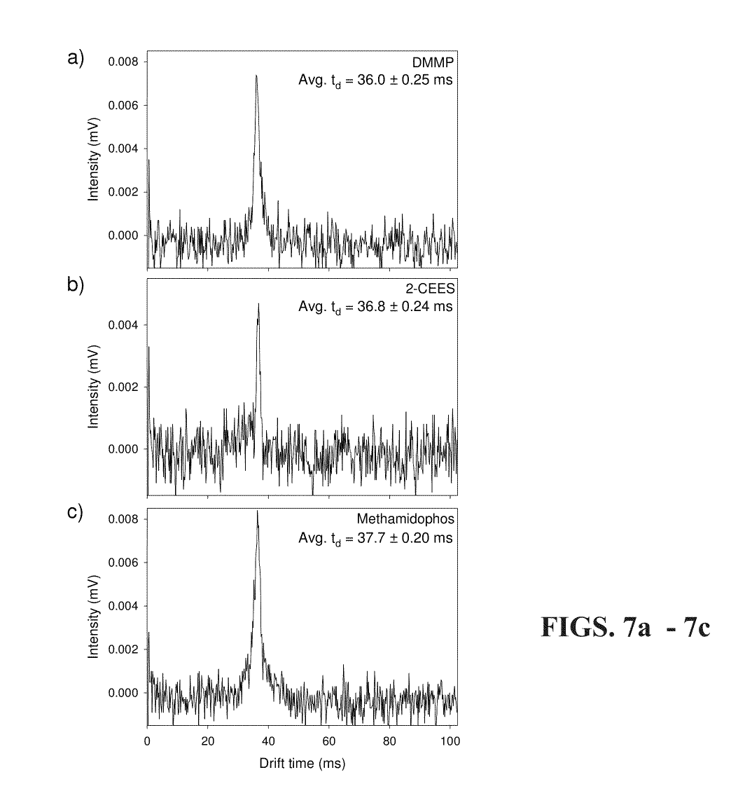

At the calculated TPD levels, 24 replicate experiments for each analyte resulted in positive detection for all trials (FIGS. 7a-7c). The average drift time, and reduced mobility for DMMP was 36.0±0.25 ms and 1.38±0.01 cm²V⁻¹s⁻¹, respectively. This matches the literature value of the protonated dimer of DMMP. The average drift time and reduced mobility for 2-CEES was 36.8±0.24 ms and 1.35±0.01 cm²V⁻¹s⁻¹, respectively. The average drift time and reduced mobility for methamidophos was 37.7±0.2 ms and 1.32±0.01 cm²V⁻¹s⁻¹, respectively. There was no literature reduced mobility values found for both 2-CEES and methamidophos, however their reduced mobilities are very close in value to the established protonated dimer reduced mobility of DMMP.

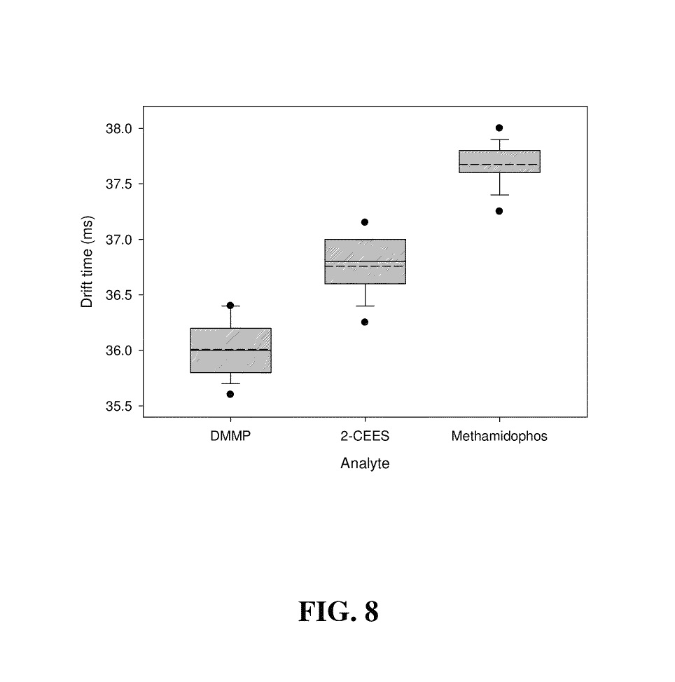

To ensure that the detected species are indeed different and not contaminants in the system, the mean, median, lower, upper and interquartiles of each analyte were plotted in a box plot and were found to be exclusive of each other (FIG. 8). The high outlier for DMMP is on the border with the lower quartile range marker of 2-CEES and the lower outlier of 2-CEES overlaps with the upper quartile range of DMMP, but these points would not significantly change the identification based on all the results. Therefore, the results suggest that the detected species of 2-CEES and methamidophos are distinct ions and probably dimers although without mass identification or literature reduced mobility values to compare to, no definitive identification can be made at this time.

For the previous experiments, a traditional pulsed IMS approach was used on the ion beam to create a discrete ion packet. Data was acquired in what is commonly called signal averaging mode which carries a drawback: only when the ion gate is closed (no pulsing) will ions be detected. In addition, as detection is occurring any new ions formed from the ionization source are lost due to neutralization against the closed ion gate. For instance, in the current set-up the ion gate pulse width was 400 μs (one element) and each run lasted 102.4 ms (a 256 element sequence). The maximum theoretical duty cycle (the temporal ratio of the pulse width to experiment length) is ˜0.4%. In this scenario, >99% of the ions formed will never be analyzed. One approach to mitigate low duty cycle would be to increase the gate pulse width. Lengthening the width may improve the total amount of ions and therefore, the sensitivity of the experiment (if noise is held constant), but there would be a loss of resolving power.

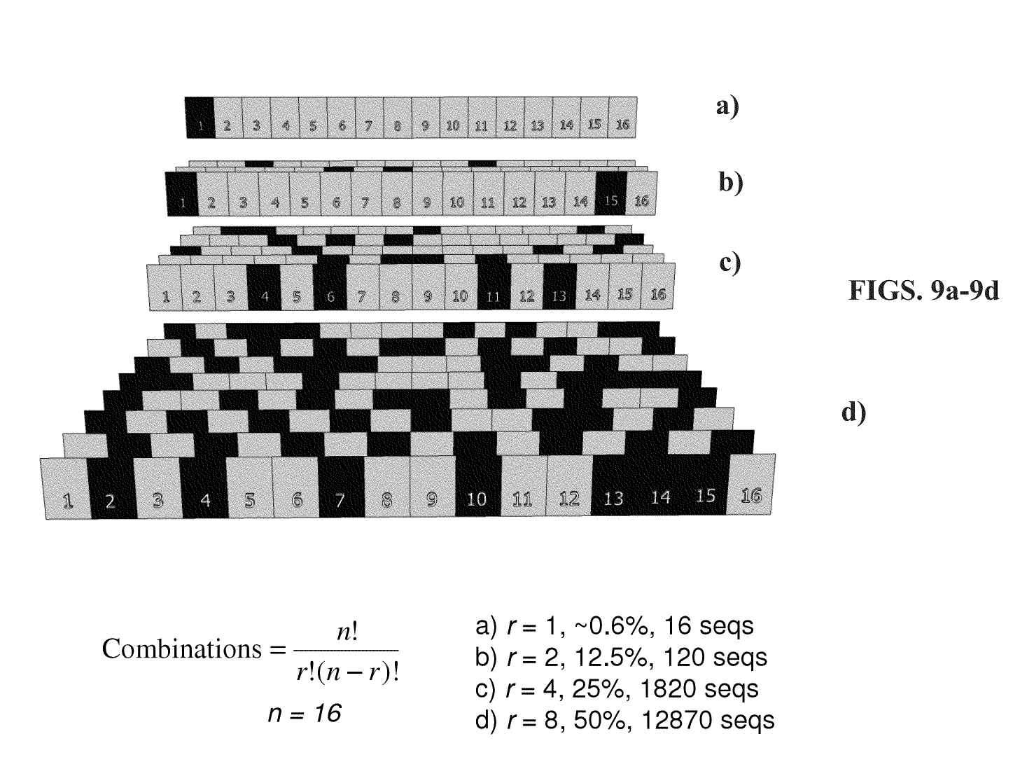

Multiplexing with IMS aims to increase the duty cycle of the analysis and improve the sensitivity (signal-to-noise ratio) and potentially reduce the time required to conduct the experiment without changing anything of the physical instrument itself. Multiplexed DTIMS injects multiple packets of ions successively throughout the sequence. The immediately recorded spectrum is convoluted, and appears as nothing but noise. However, by knowing the gate pulse widths, the sequence of the openings, and the ions' arrival times, one can deconvolute the signal and generate a clean spectrum. For example, in a traditional IMS experiment, the gate would open in the beginning of the run and then close until all ions were detected. If the sequence was 16 elements in length, only the first element would represent an open gate (FIG. 9a). Here, the duty cycle would be 6.25%. A multiplexed approach would add more injections to the sequence to increase the total amount of ions sampled. Ions could be injected for 2, 4 or 8 elements selected randomly along the 16-element sequence representing duty cycles of 12.5, 25 and 50%, respectively (FIGS. 9b-9d). The total number of combinations of injections is dependent on the length of the sequence (n) and the amount of open injections (r) defined by (Eq. 5):

$$Combinations = \frac{n !}{r ! ( n - r ) !} \qquad ( Eq . 5 )$$

For the previous examples, there are 120, 1820, and 12870 different sequences possible for the 2, 4, and 8 multiplexed injections for a 16 element sequence, respectively.

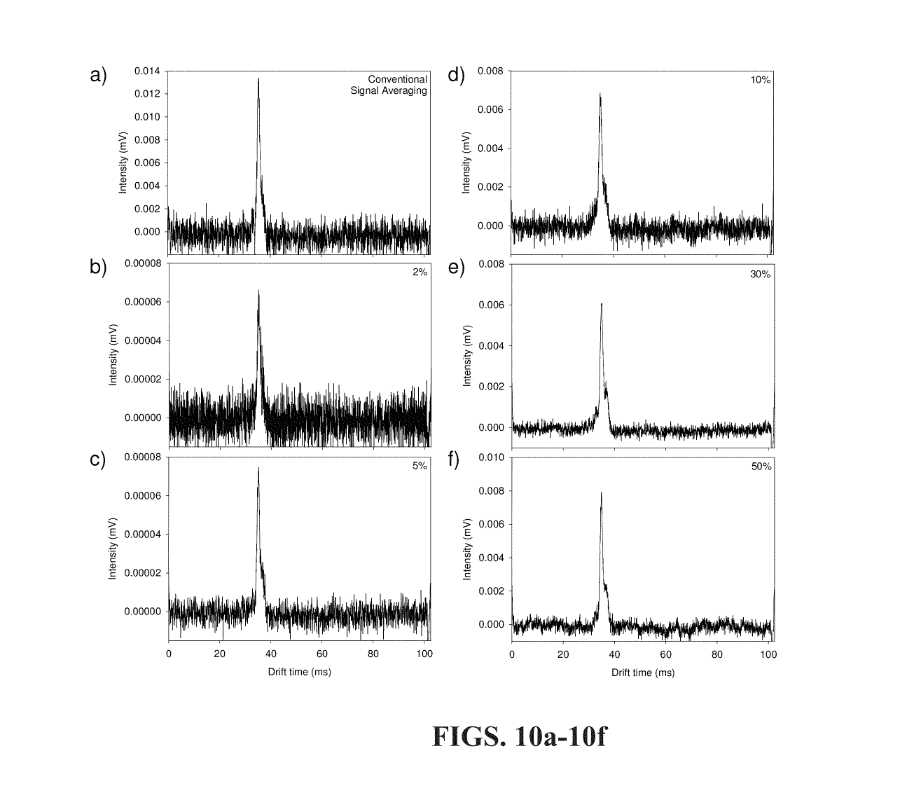

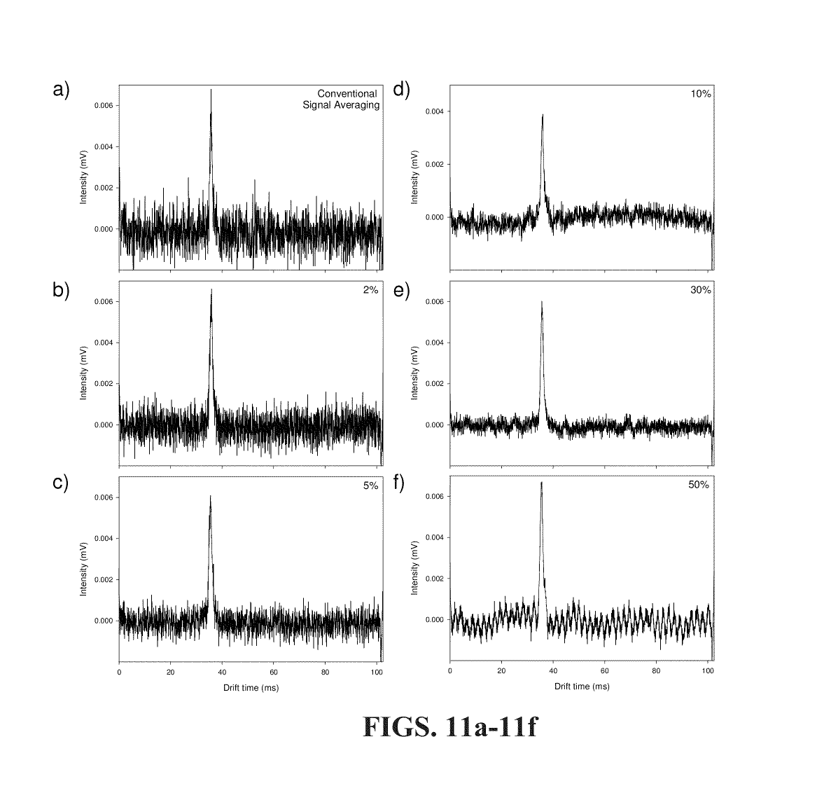

In order to improve the detection capabilities and speed of the analysis of the DART-IMS platform, digital multiplexed IMS was investigated. Only one analyte, DMMP, was investigated since there was positive identification of the detected species formed during conventional signal averaging mode analysis. Conventional signal averaging of 400 runs at a ˜0.4% duty cycle (400 μs gate pulse and 50 μs acquisition windows) had a signal-to-noise ratio of 4.2 (FIG. 10a). For 2, 5 and 50% duty cycles, the signal-to-noise ratios were 2.5, 4.2, and 4.2 respectively (FIGS. 10b, c and f). The lack of improvement is probably due to the particular sequence selected to run the experiment. The increase in noise and lack of improvement of the higher duty-cycle trials compared to the conventional signal averaging spectrum are a common result of the specific distribution of gating events (when the ion gate is open with respect to the total sequence).

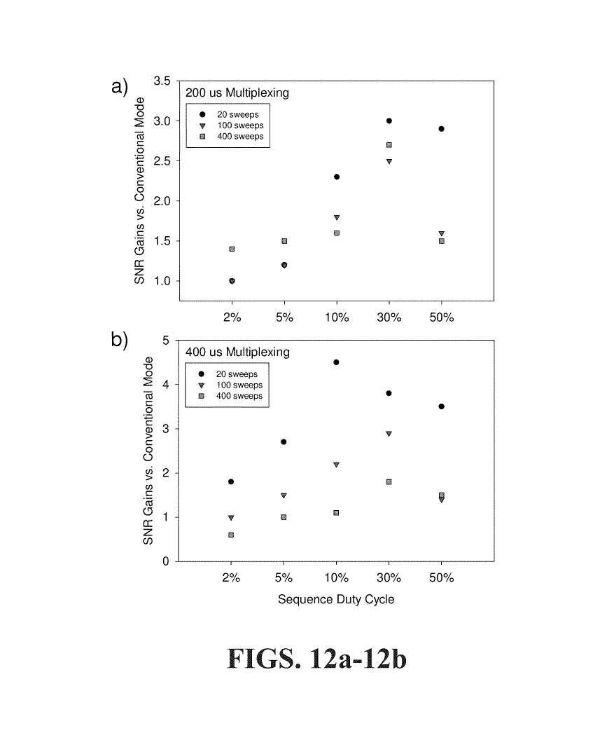

In the case of the 2% spectrum, this is one sequence of more than >8.8·10⁹ possible combinations. Other spectra recorded at 10 and 30% duty cycles showed an improved values of signal-to-noise ratios of 4.6 and 7.6, respectively (FIGS. 10d and e). The same experiment but with a 200 μs gate and 50 μs acquisition windows for signal averaging mode has a signal-to-noise ratio of 2.2 which is below the minimum standard of chemical detection at a signal-to-noise ratio of 3 (FIG. 11a). Conversely, at 2, 5, 10, 30, and 50% duty cycle sequences at 400 sweeps averaged should improved signal-to-noise ratios of 3, 3.2, 3.5, 6 and 3.3, respectively (FIG. 11). In addition to the 400 sweep average of runs conducted in all the examples so far, additional experiments were performed at 20 and 100 sweep averages. The multiplexed gains of the 200 and 400 μs gates for all sweep averages over conventional mode are shown in FIG. 12. The greater signal-to-noise ratio gains of the lower spectral sweep averages is due to two factors. First, traditional signal averaging experiments have too much noise in the baseline and prevent the observation of any signal with only 20 or 100 sweep averages. As a result, any signal observed for the multiplexed sequences will be higher than the signal averaging experiments and this is shown at its maximum at both the 20 sweep averages of the 30% 200 μs and 10% 400 μs signal-to-noise ratio gains of 3 and 4.5, respectively (FIGS. 12a and 12b).

For comparison purposes, a more traditional 50% duty cycle method was probed utilizing Hadamard Transform (HT) sequences.

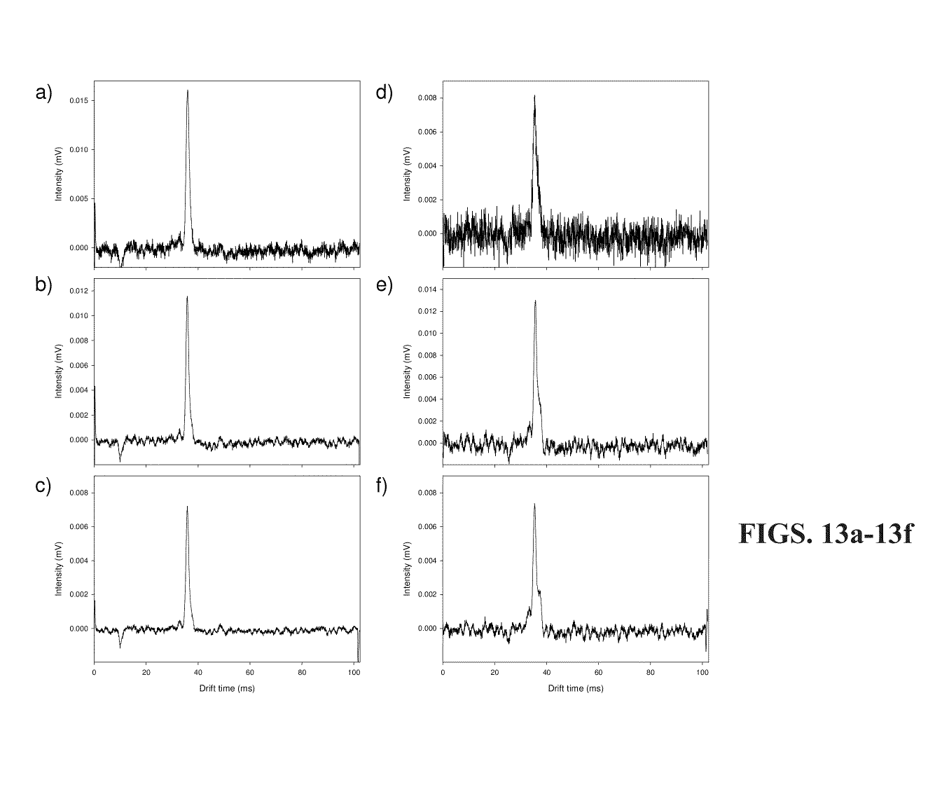

For both 200 μs and 400 μs gate widths at 20, 100, and 400 sweep averaged runs HT sequences showed signal-to-noise ratio gains over conventional signal averaging experiments (FIG. 13). The greatest gains correlated to 20 sweep averaged runs at 200 μs gates with a gain of 8 over conventional mode (FIG. 13a). However, accompanying these gains were spectral defects in the acquired spectra. These defects were most noticeable with the 200 μs gates appearing as negative peaks at drift times of 10.45, 9.95, and 10.05 ms for 20, 100, and 400 sweeps averaged, respectively (FIG. 13a, b and c). Smaller defect peaks were observed with 400 μs gates at drift times of 24.95, 25.30 and 25.35 ms for 20, 100, and 400 sweeps averaged, respectively (FIG. 13d, e and f). Defect peaks are due to imperfect ion packet shapes within the drift tube created by the mathematical properties of Hadamard-type sequences. All these defects manifest themselves negatively as ghost or echo peaks. These defects may ultimately result in false-positive or false-negative detections.

The experiments above provide the first results of a ambient plasma ion source coupled to a drift tube atmospheric pressure ion mobility spectrometer, and show the ability to detect and identify toxic chemicals including chemical warfare simulants and low vapor pressure chemicals with statistically significant results. Digital multiplexing techniques were utilized leading to improved signal-to-noise ratio gains over conventional signal averaging experiments, and without artifacts as with Hadamard multiplexing approaches.

Repeller: An Effective Ion Transmission Scheme for Ambient Plasma-Based Discharge Sources Coupled with Drift Tube Ion Mobility Spectrometry

As previously discussed, IMS is a well-established analytical technique used for the separation and detection of gas phase ions. In principle, ions propagating through a carrier gas under the influence of an electric potential gradient possess unique mobilities derived from their size/charge ratios and can be separated and tentatively identified by their specific drift times or velocities. The oldest embodiment of this technique, drift tube IMS (DTIMS), has been developed in the past few decades for use as a standalone detector commonly employed in screening applications for chemical warfare agents, explosives, environmental contaminants, foods, and pharmaceuticals.

IMS detectors offer good sensitivity with fast analysis times and resolving powers typically superior to LC-UV systems, while also permitting detection of optically non-active compounds. In tandem with rapid technological advancements in mass spectrometry, DTIMS stages have now become routinely integrated in mass spectrometers for higher resolution multidimensional separations and conformational analysis based on collision cross-section.

Much effort in IMS development has been devoted to enhancing two key performance characteristics—sensitivity and resolving power. Optimization of the physical parameters that govern resolving power and the corresponding theory are extensively reviewed in the literature, so will be overlooked in lieu of discussing some more persistent sensitivity issues involving DTIMS systems.

Operating in the conventional mode, DTIMS sensitivity is inherently limited by low duty cycles (≦0.01%), where ions are only gated into the instrument over a short microsecond window for comparatively longer scan durations of several milliseconds. Longer shutter pulse widths increase the effective ion density of the gated signal packet, but improve sensitivity at a growing cost to resolving power owing to band-broadening effects. These low duty cycles can be overcome and signal-to-noise enhanced by performing multiple short-width gating events per scan (multiplexing) and subsequently deconvoluting the signal (de-multiplexing).

In instances where IMS is paired with mass spectrometry, sensitivity can be improved by ion trapping prior to injection. However, these systems are operated at reduced pressures (10⁻³-10⁻⁵ torr), diminishing the total mobility resolution possible. Standard atmospheric pressure DTIMS instruments offer much greater resolving power than their reduced pressure equivalents, but necessitate relatively large electric field strengths on the order of ≧300 V·cm⁻¹ to effectively propel ions through the buffer gas for detection. Due in part to the magnitude of this electric field, sensitivity remains a considerable challenge in modern AP-DTIMS systems, particularly for those systems implementing new generation plasma-based sources and ambient desorption/ionization schemes.

Efficient ion transmission for AP-DTIMS is greatly inhibited by two primary factors being 1) a large repulsive electric field at the IMS inlet proportional to the field strengths required for electrophoresis at atmospheric pressure, and 2) turbulent fluid dynamics within the counter-flowing drift gas. Modern DTIMS has typically been coupled with corona discharge, electrospray, or chemical ionization. Sensitivity losses arising from poor ion transmission are far reduced using these sources because ion formation occurs within the instrument desolvation region and the confines of the electric field gradient. Despite high ion currents and transmission efficiencies, corona and electrospray are primarily restricted to ionization of volatilized organics and nebulized solutions. Furthermore, these sources are prone to analyte fragmentation and ion suppression, which can unfavorably increase spectral complexity in lower resolution IMS detectors.

Newer ambient ionization techniques refined for mass spectrometry have garnered attention as attractive alternatives to contemporary AP ion sources. These methods have grown increasingly useful for probing surface chemistries while often affording softer, chemically selective ionization. Some of the more notable techniques developed in the past two decades are desorption electrospray ionization (DESI), laser desorption-atmospheric pressure chemical ionization (LD-APCI), desorption atmospheric pressure photoionization (DAPPI), and direct-analysis-in-real-time (DART).

Noted above, successful pairing of such ambient sources with DTIMS has proven exceedingly difficult though where the ionization process takes place external to the instrument. IMS coupled with discrete DESI sources has only been reported for reduced-pressure IM-MS systems where ion transport is vacuum-assisted. Likewise, DTIMS paired with laser ablation has required hybrid source setups employing corona discharge or electrospray to assist ionization and transmission.

In this additional exemplary embodiment of the present invention, a new ionization scheme is presented to address the sensitivity limitations of DTIMS detectors that stem from poor ion transmission at the source-instrument interface. The initial design for this new ionization source comprises a DART-SVP plasma ion source and repeller point electrode. Ion transport into the DTIMS is facilitated by a repeller electrode that effectively defines the electric field shape and strength at the IMS inlet.

It is purported that the mechanism of ion formation prior to transmission is predominantly DART-based and remains distinct from corona discharge; however, some experimental evidence suggests that secondary ion formation induced by photon or metastable bombardment of the repeller electrode may be concomitantly occurring. Performance characterization for various source configurations was conducted. The source capabilities and limitations for solid screening applications are showcased as well. Significantly, this ionization scheme holds promise for adaptation with DTIMS using other ambient ionization methods like LD, DAPPI, or microplasma sources.

### Experimental

### Materials and Reagents

All chemicals were purchased from Sigma-Aldrich (St. Louis, Mo.) as analytical grade and used without further purification. Solutions of 2,6-di-tert-butylpyridine (2,6-DtBP, ≧97%) were prepared by dissolution in methanol (HPLC grade) or ultra-pure water (18.2 MΩcm⁻¹, Barnstead Nanopure Diamond, Van Nuys, CA) in concentrations ranging from 5 to 50 mM. Over-the-counter tablets of acetaminophen (500 mg acetaminophen) used were Target Brand, Inc (Minneapolis, Minn.). Nitrogen (99.995%, Airgas, Atlanta, Ga.) was used as the IMS buffer and DART source gas. Tungsten (2% Thoriated) and Mo-doped M2/M7 steel rods (0.400 mm dia.) were procured from McMaster-Carr and precision ground to points ( 1/10000″ tolerance) at Georgia Tech for use as repeller electrodes.

Instrumentation

The drift tube ion mobility spectrometer used in this study has been described in detail in previous publications, but will briefly be presented again here. The IM spectrometer is constructed of two monolithic resistive glass cells (PHOTONIS USA, Sturbridge, Mass.) with a resistance of 0.45 GΩ·cm⁻¹. The desolvation and drift regions measure 12 cm and 26 cm, respectively, with 3 cm i.d. and 4 cm o.d. dimensions. The two cells are separated by a Bradbury-Neilson style ion gate (TOFWERK AG, Thun Switzerland). When the gate is closed, a floating potential of ±35 V is applied across the adjacent sets of wires. An iridited aluminum Faraday plate detector (2.6 cm dia.), spaced 6 mm apart from an aperture grid, is fixed at the end of the drift cell and connected to a custom-built amplifier (TOFWERK AG). Voltage provided to the instrument via a high-voltage power supply (FUG HCL 14-2000, Magnavolt Technologies, Plattsburgh, N.Y.) is passed through a voltage divider to four electrode contacts connected at the entrance and exit of each IMS cell. With an IMS entrance potential of 12,000 V, the approximate electric fields are 180 V cm⁻¹ for the desolvation cell and 370 V cm⁻¹ for the drift cell. Drift gas enters the drift cell behind the anode and is controlled using a precision flow analog manometer (PMR 1, Del-ART/Scienceware, Pequannock, N.J.). Ion gate timing is software-triggered and performed synchronously with data acquisition using a NI 5411 arbitrary waveform generator and NI 6111 ADC with in-house custom software developed on Labview 7.1 (National Instruments, Austin, Tex.).

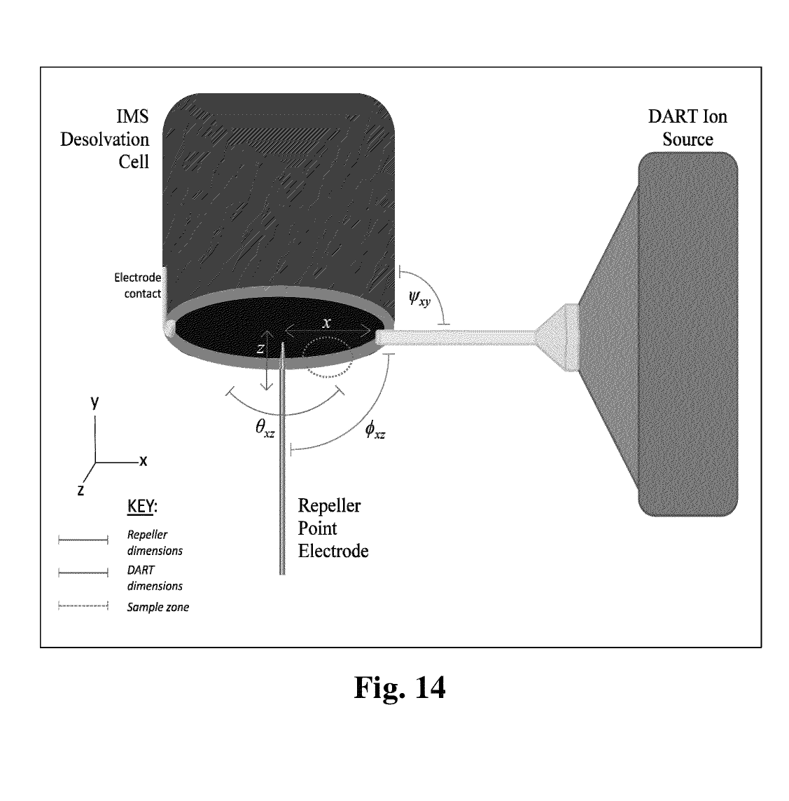

The starting configuration for the repeller-assisted DART source assembly is depicted in FIG. 14. A DART-SVP ion source (IonSense, Inc. Saugus, Mass.) is positioned orthogonally to the IMS inlet. A glass capillary (L=4.0 cm, 0.15 cm i.d., 0.30 cm o.d.) extends from the DART outlet approximately 2 mm past the inner lip of the IMS opening. The repeller electrode (L=3.5 cm, 0.400 mm dia.) is connected to a high-voltage power supply (Bertan Associates, Inc. Series 205B, Hicksville, N.Y.) independent from the IMS supply. The repeller is coaxially centered normal to the face of the IMS entrance, spaced more than 1 cm from the DART capillary.

Parameter Space Exploration and Sample Analysis Procedure

The DTIMS was operated at ambient temperature with an applied entrance potential of +12,000 V and N₂ drift gas flow rate of 1 L/min. DTIMS program settings used in all experiments were: gate pulse width, 100 μs; data acquisition rate, 100 μs; scan averages (sweeps), 400; and total scan time, 102.4 ms. The DART-SVP source was operated in positive ion mode between 25 to 400° C., using a grid voltage of +500 V and N₂ flow rate of 2.5 L/min.

Signal intensity as a function of source component potential and position were studied systematically, including the repeller depth inside the IMS entrance, as well as the repeller and DART angles relative to the IMS. The repeller was clamped to a stative mounted on precision motion translational stages for accurate manual positioning. Repeller potentials were adjusted between 12,800 V and 14,500 V and repeller tip depths were varied between 0 mm at the IMS entrance to 12 mm inside the IMS.

The repeller point was rotated on axis between 60° to 120° (90° coaxial) and DART capillary angles were shifted from 0° in plane with the face of the IMS inlet to 60° away, adjoining the repeller rod. For repeller and DART angle measurements, the repeller depth was fixed approximately 5-7 mm inside the IMS inlet, where observed signal stability was greatest. In addition, the end of the DART capillary was kept exterior to the IMS inlet and situated approximately 1 cm from the center of the IMS entrance across all angles.

For characterization studies, sample vapor was introduced by slowly bubbling 5 mL aliquots of solution in a 20-mL scintillation vial through a glass capillary (0.32 i.d., 0.64 cm o.d.) proximate to the IMS inlet, thereby generating a consistent, focused analyte plume in the reaction region. The standard IMS calibrant 2,6-DtBP was selected for these experiments because of the compound's low clustering affinity across a broad range of temperatures and pressures, giving a single, reproducible reduced mobility value (K₀=1.42 cm² V⁻¹s⁻¹). Solid analysis was conducted with the DART-SVP set in one of two configurations. In arrangement one, the DART was angled 45° over the target tablet centered within a few millimeters the IMS opening. arrangement two, the DART was oriented orthogonal to the IMS inlet and set across from the target tablet 5-10 mm below the coaxial repeller. For these experiments, the repeller electrode remained coaxial, but was up to 6 mm offset from the center of the inlet above and away from the DART capillary. Tablet surface desorption temperatures were recorded using an FLIR T300 digital infrared camera (FLIR Systems, Inc., Boston, Mass.).

Ion Source and System Characterization

The repeller-assisted DART source concept originates from the point-to-plane electrode and corona ionization scheme routinely paired with DTIMS and MS. A high voltage point electrode generates a large potential energy gradient and intensely focused electric field lines near its tip. The effect as envisaged for the present setup was coarsely modeled in Simion 8.1 and is shown in FIG. 19. Interfaced with DTIMS, this point electrode can function as a repeller if biased below the breakdown potential, enhancing the electric field profile at the IMS inlet to facilitate ion transmission from alternative ambient ion sources. Herein, the performance of an AP-DTIMS instrument coupled with a DART plasma discharge source using this repeller electrode motif is analyzed. The initial configuration for the repeller-assisted DART assembly is depicted in FIG. 14.

In basic characterization studies, key parameters including repeller electrode potential and the repeller and DART positions relative to the IMS inlet were systematically investigated. The results are subject to a number of interpretations regarding the combined electric field defined by the repeller and IMS.

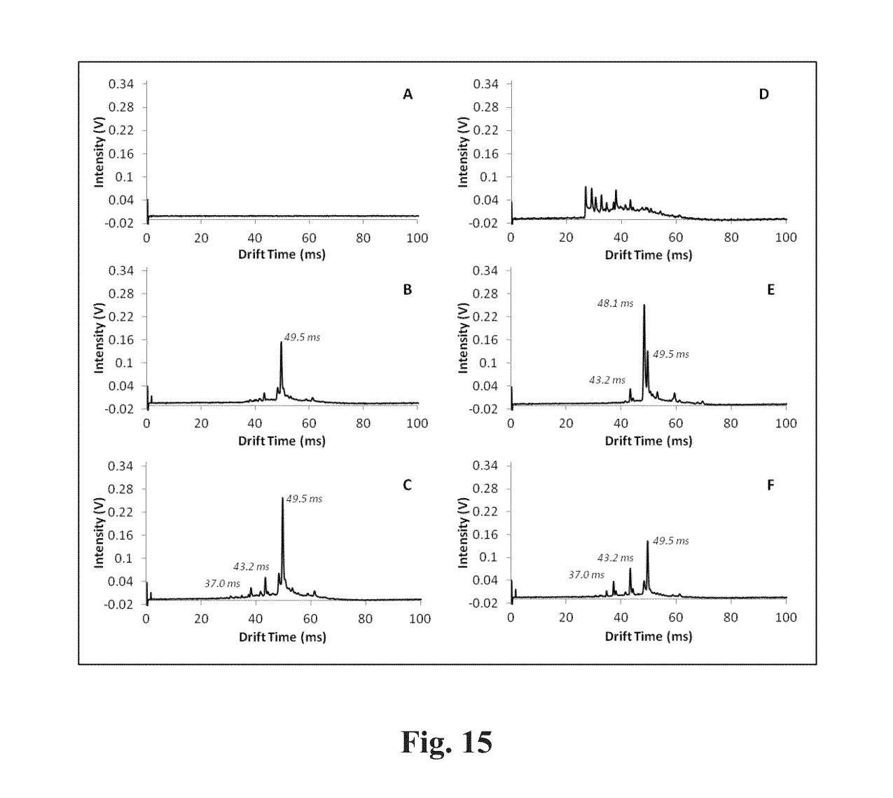

The high repeller potentials used in the present point-to-plane electrode arrangement encroach on the threshold of the Townsend breakdown regime. So a simple proof of concept is shown in FIG. 15 confirming and distinguishing DART dependent and corona discharge based signals for an acetaminophen sample tablet. The repeller electrode was operated ≧1,000 V above the IMS inlet potential (12,000 V) in order to define an electric field gradient conducive for ion injection.

Between spectrum A and B, it is readily apparent that no signal is observed without the DART discharge active when a repeller potential of 1500 V above the IMS inlet is applied. While spectrum E shows the corona signal in the absence of a DART discharge for a repeller needle 2500 V above the IMS inlet potential. Further comparison of corona discharge versus DART ionization with DTIMS will be discussed below, where more inferences are drawn from the ion mobility spectra. In future parameter space experiments, optimal source component arrangement and electrode potential settings were evaluated on the basis of measured signal intensity for a 2,6-DtBP standard. The identity of the solitary spectral peak observed for the 2,6-DtBP protonated monomer was confirmed by the reduced mobility coefficient, calculated using the Mason-Schamp equation and the drift time measured on the instrument (K₀=1.40±0.02 cm² V⁻¹s⁻¹).

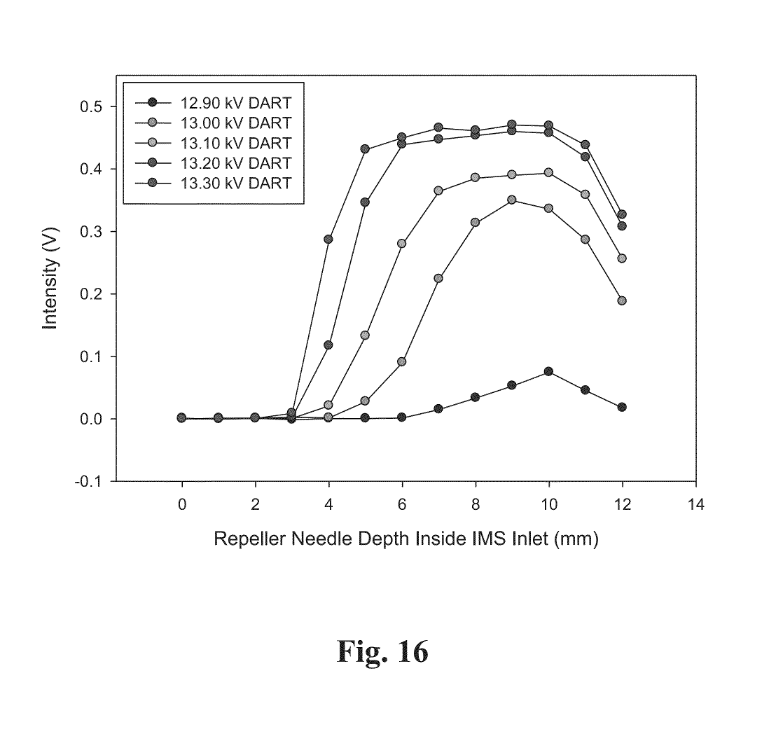

Referring again to the source configuration in FIG. 14, signal intensity as a function of both repeller potential magnitude and electrode depth inside the IMS entrance was examined. At a given potential, as the centered coaxial repeller electrode protrudes deeper into the IMS interior from 0 mm at the plane of the IMS inlet up to 12 mm inside, signal for 2,6-DtBP increases and plateaus before abruptly declining. Peak height scales with increasing repeller potential between 12 900 V and 13,300 V, starkly rising to level intensities at higher potentials, but to a gradually tapering degree. FIG. 16 shows the trend.

It can be reasoned that at higher potentials, the electric field lines emanating from the repeller are denser, better shaping the field profile and potential energy contour for transmission of ions generated by the DART source. In addition, the effective potential difference between the repeller needle and IMS tube is greater with increasing repeller depth along the IMS electric field gradient. So peak intensity increases accordingly, paralleling the signal behavior observed with larger repeller potentials. Despite the ample sample concentration, eventually signal intensity becomes limited by the DART reactant ion population, indicated by the diminishing maximum peak heights at higher electrode potentials. It is speculated that the signal drop off past tip depths of approximately 10 mm is likely attributed to a net repulsive or imbalanced electric field at the IMS opening that forms in response to a reduced field-focusing effect from the “buried” repeller point.

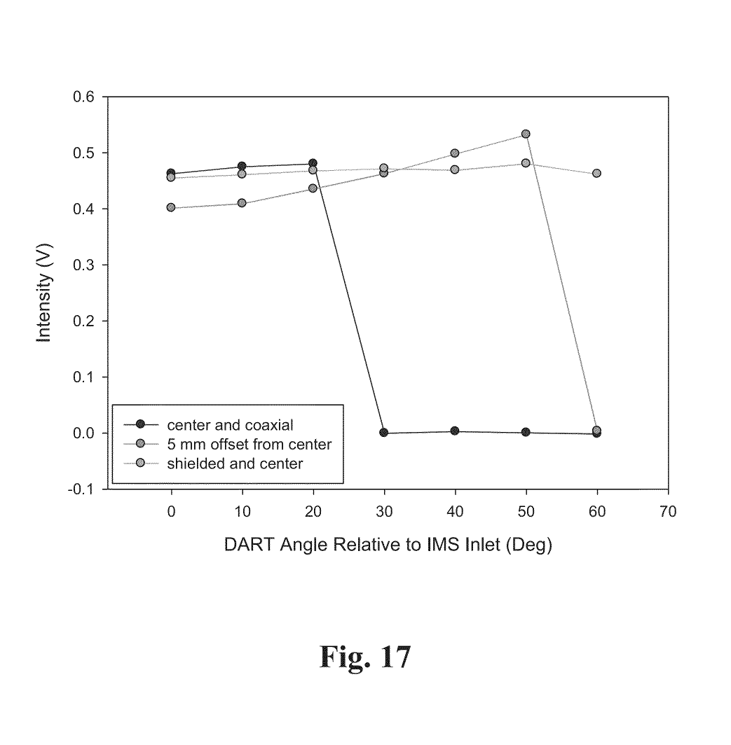

More fundamental studies were aimed at determining how the DART and repeller angles relative to the IMS inlet impacted signal intensity. For these experiments, the repeller needle was set a fixed distance inside the IMS inlet (7 mm) where the electric field is well-defined and the signal intensity reaches a level maximum for electrode potentials greater than 13,000 V. Moving the DART capillary from orthogonal at the IMS face (0°) up to a 60° angle nearing contact with the bare repeller electrode, signal is observed to quickly vanish past a modest 20° angle (FIG. 17).

When sliding the coaxial repeller 5-6 mm off-center and away from the DART capillary, signal is restored for a DART angle approaching 50°. (Conversely, increasing the lateral proximity of the coaxial repeller to the orthogonal DART capillary by 5-6 mm squelches all signal regardless of DART angle). These results suggest an electronic aberration between the components that disrupts ion formation and transport, namely repulsive field effects at the repeller rod or from DART capillary charging. The distortive effects can be mitigated further by shielding the coaxial repeller rod. Signal intensity was again observed across the full 0°-60° range inspected using generic coaxial shielding stripped from a copper wire and slipped over the repeller rod (needle point left exposed).

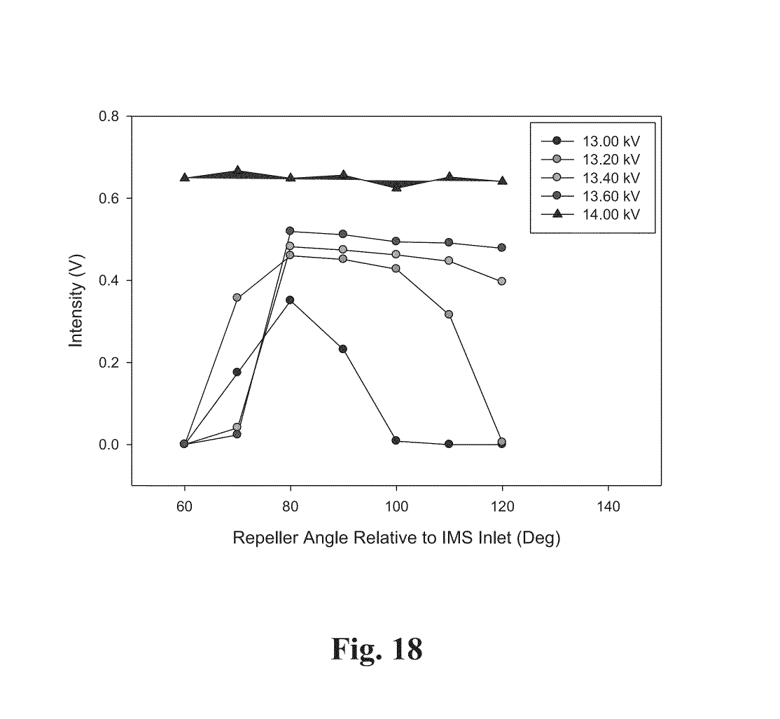

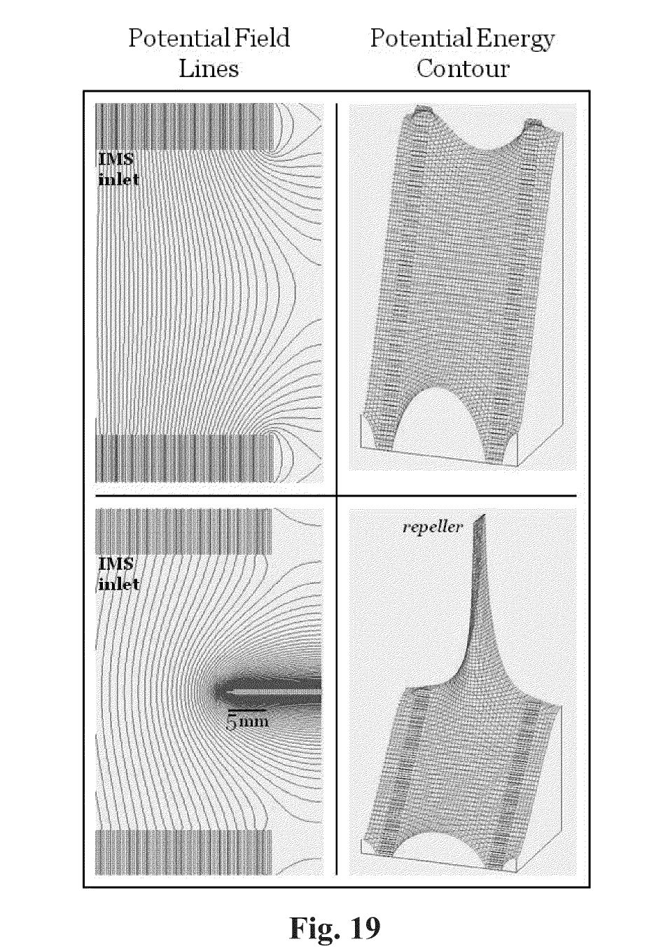

These findings are in accord with repeller angle experiments, which also show a heavy signal reliance on electrode positioning (FIG. 18). With the DART again stationed orthogonally, maximum peak heights were repeatedly observed for a repeller alignment near coaxial with the IMS axis. Signal drops off sharply due to repulsive field effects as the repeller approaches the DART capillary at acute angles (≦70°) and degrades at a much slower rate over more obtuse angles (≧100°), likely from erratic ion transmission.

Greater peak intensity is expectedly observed for higher repeller potentials with stronger field lines which help to dampen ion transmission loss at wider angles. Signal appears stable across all angles for corona discharge at 14,000 kV, where ionization localized on the plasma tip inside the IMS inlet is less susceptible to poor ion transport arising from electric field inhomogeneity at the orifice.

Trial Application: Solid Drug Analysis

Paired with DTIMS, the repeller-assisted DART source is suitable for liquid and volatile analysis, but the more attractive utility of DART is solid sampling via thermal desorption. FIG. 14 represents a prime example, in which the capability of the DART-DTIMS setup for drug screening was assessed using an acetaminophen tablet. A large peak for acetaminophen is evident at t=49.5 ms in spectrum B. Given the calculated mobility coefficient (K₀=1.14 cm² V⁻¹s⁻¹), the peak likely represents an acetaminophen dimer clustered with ambient water. In spectrum C, signal intensity for this same peak is shown to increase with the repeller voltage biased to the corona breakdown potential.

The spectrum is characteristically similar to B, with smaller peaks appearing more clearly at lower drift times t=43.2 ms and t=37.0 ms. These two peaks better correlate with the reduced mobility values for the protonated dimer (calc. K₀=1.30 cm² V⁻¹s⁻¹, lit. K₀=1.36 cm² V⁻¹s⁻¹) and protonated monomer (calc. K₀=1.51 cm² V⁻¹s⁻¹, lit. K₀=1.53 cm² V⁻¹s⁻¹), respectively. The intermittent manifestation of the peak at t=43.2 ms in other tablet formulas suggests it is not unique to acetaminophen and may be an excipient, environmental in origin, or correspond to an ion-bearing atmospheric molecule clusters formed following collisional displacement from the analyte. However, proper identification could not be performed for these peaks without accurate mass.

The signal in spectra B and C are both specific to DART over corona discharge, as can be confirmed from spectrum D. With the DART discharge off and only corona enabled, the signal dissolves into the broad RIP band for protonated water clusters exchanging with atmospheric gas. The DART gas temperature was not sufficient to desorb acetaminophen without the plasma active. Indeed, the effective tablet surface temperature recorded with an IR camera measured around 75° C. with the discharge off, approximately 50° C. lower than with the plasma glow on and much lower than the designated DART heater temperature (300° C.). Increasing the DART heater temperature (450° C.) restored signal for corona in spectrum E, and the tablet temperature visualized again with the IR camera was comparable to B-C (˜120° C.). The peak distribution is shifted slightly for the corona discharge spectrum, with the tallest signal shown at t=48.1 ms, possibly corresponding to a less clustered species formed in the more energetic corona. In spectrum F, with DART active over corona at a higher gas temperature, the tallest peak is shifted back to t=49.5 ms with a new spectral equilibrium showing enhanced signal for the higher mobility ions. As known, clustering dynamics at the IMS interface depend heavily on temperature, analyte concentration, and residence time in the reaction region.

System performance using repeller-assisted DART was admirable for acetaminophen in FIG. 15. A prospective advantage using this mode for mixture analysis is posed in B, where under ideal temperature and electrode potential conditions, the DART-based signal may appear less complex than the corona discharge spectrum. However, some data exposes a set of limitations for solid screening that relates to the DART thermal desorption capacity and ionization energy. Corona discharge and DART spectra are shown for 2-component drug mixtures, one analgesic/stimulant tablet Doralgine (25 mg caffeine, 500 mg noramidopyrine) and an anti-malarial tablet P-Alaxin (40 mg dihydroartemisinin, 320 mg piperaquine diphosphate). For corona discharge, DART heater temperatures were raised 150° C. to approximate the higher tablet surface temperatures seen with active DART plasma. For both of these samples, corona ionization performed equal or superior to the repeller-assisted DART scheme.

DART alone was unable to ionize either Doralgine ingredient with acceptable intensity or resolution, showing only a broad spectral hump. In contrast, corona discharge at elevated temperatures showed numerous peaks, with the spectrum dominated by a high signal at t=58.9 ms (K₀=0.96 cm² V⁻¹s⁻¹). This signal can be equated with a noramidopyrine ion species, denoted by the drift time and spectral appearance closely matching a 4-aminoantipyrine standard. There was no spectral overlap observed with a caffeine standard, indicating possible ion suppression of the caffeine signal by the more abundant noramidopyrine analyte under the given conditions. Small peaks are also observed at t=49.2 ms and t=36.9 ms, similar to the drift times observed for the DART generated acetaminophen ion.

Both noramidopyrine and acetaminophen are analgesics with analogous structures, suggesting the two peaks might resemble fragments associated with acetaminophen or declustered adducts. For P-Alaxin, dihydroartemisinin was the only identified compound, confirmed with a DHA standard. Piperaquine diphosphate as the protonated monomer or diprotonated monomer was not observed over drift times up to 200 ms. Given the number of basic sites on the molecule and larger tablet concentration, ionization should have been achieved by either DART or corona. For this ingredient, it seems thermal desorption was the limiting factor using DART and N₂ gas.

The DART source is only capable of heating a tablet surface up to 200° C. at maximum heater settings using nitrogen gas rather than Helium. Excessive discharges and arcing at the IMS interface precluded the use of Helium in the setup. In addition to less efficient thermal transfer, the first excited state N₂* energy is also relatively low (˜9.8 eV) compared to He* energy states (19.8-20.2 eV). Depending on tablet packing density, these temperatures may not be adequate to desorb heavier analytes (m/z>450 Da).

Likewise, the DART N₂ metastable energy may be too small to facilitate declustering of the desorbed particulates. The low energy of N₂* theoretically forbids direct Penning ionization of N₂, O₂, H₂O, and CO₂ species in air to form primary ions. Therefore, a probable DART mechanism in the preset setup is the strictly ionic dissociation of water clusters into [(H₂O)ₙH⁺] and [(H₂O)ₘ₋ₙ(OH)⁻] initiated via metastable collision. Unless excited DART molecules induce electron emission and secondary ion formation at a metal electrode surface (i.e. the DART grid electrode or repeller), as eluded to in the next section, proton transfer/adduction is the primary pathway for ion formation with N₂ DART.

In light of these drawbacks, DART performance seems to fall short of higher energy corona discharges for solids analysis using DTIMS. But where resolution and sensitivity are low for poorly desorbed or declustered analytes, DART-DTIMS could still serve useful for compound identification based on peak pattern recognition using thermal desorption profiles. Alternatively, the repeller motif might be coupled more effectively with laser ablation, photoionization, or a higher energy plasma to afford superior desorption and ionization efficiencies.

### Mechanistic Considerations

Based on this suite of characterization and brief application studies, it appears that when using DART, the ions formed are DART specific and signal behavior is a consequence of the refined electric field profile governing ion transmission at the electrode-IMS interface. However, alternative mechanisms that may clarify some curious observations. These observations involve an induced current on the repeller with an active DART source, oxidation of the repeller electrode after prolonged use, and in rare instances when using the source configuration as described, a subdued “glow” on the repeller surface. Together, these phenomena suggest a surface-moderated secondary ion formation event could in fact be occurring. Such a process is entirely feasible taking into account mechanisms of electron emission in the field of metastable spectroscopy. In addition to the signal rationalized by electric field-enhanced ion transport, secondary ion formation acting as an alternate ionization pathway introduces another speculative origin for signal generation with the repeller-assisted DART assembly.

While electric field fidelity at the source-instrument interface remains critical, evidence for signal contribution from the supposed secondary ion formation process appears more circumspect. Variations in signal intensity with the orthogonal DART capillary aimed ˜5 mm above or below the coaxial repeller are trivial. The fairly collimated DART gas stream is not in line to grossly contact or envelop the electrode when the DART capillary is thus shifted, especially with the repeller point at a fixed distance inside the IMS inlet. Signal spawned from high-energy metastable collisions at the electrode in this staggered repeller/DART conformation should be relatively small to nonexistent, relying on transient diffusion of the excited molecules out of the high-flow DART gas stream without impetus from an appropriately biased electric field.

A similar argument applies looking again at FIG. 17, where signal intensity is uncompromised using a shielded repeller rod. Such signal behavior more likely implies ion formation and transmission occurs without being initiated by electron sputtering from metastable/photon impingement directly on the metal electrode surface, unless field lines direct collisions to the bare repeller point inside the IMS inlet. Possible secondary ion formation events might be casually explained then by quenching of the RIP negative counter-ion population on the positively biased repeller electrode. Negative species in the vicinity of the reaction region (˜180 V cm⁻¹) are apt to be extinguished at any positively biased, high potential surface—repeller or IMS tube. For large enough ion current densities near the repeller, this effect might be visualized as a “glow” from high velocity collision-induced electron/photon emission at the needle tip where the strongest field lines terminate. This process would contribute to the observed electrode oxidation and system fouling over time. Meanwhile, a definitive correlation between signal intensity and transient “glow” was not observed, evidenced in some circumstances with signal absent and the electrode glow present.

Another interesting symptom and potential mechanistic clue noted during system diagnosis concerns an induced current on the repeller electrode with an active DART discharge. Although the origin of this positive current is not yet verified, it is believed to derive primarily from the alleged quenching of negative RIP counter-ions or electrons escaped from the DART on the repeller. Indeed, higher RIP signal and also current are frequently observed with water saturated air, where protonated water clusters are the bulk species derived from predicted DART mechanisms. Again, like signal, the repeller current and glow (when observed) have been found to persist with the repeller and DART capillary in configurations where the DART discharge gas and repeller do not align. The current and sporadic glow have been seen even with the repeller point removed above and behind the DART capillary outlet, where metastables would need to reverse flow direction in order to contact the positive electrode, but negative entities could still be forcefully drawn to extinguish.

The magnitude of the induced repeller current (typically 0.1-1.0 μA) has been linked with repeller potential, and DART gas flow rate and temperature. With the DART discharge on, current measured on the repeller HV power supply is observed to increase (nonlinearly) with rising repeller potential. It is assumed that as field lines are strengthened at higher potentials, more negative ions tend to neutralize on the repeller electrode, thereby inducing a larger current. The induced current appears much greater (2.0-10.0 μA) using a larger diameter DART capillary (0.70 cm o.d., 0.49 cm i.d.) substituted in place of the narrow capillary used in all previous experiments. With a large DART capillary, the total metastable volume in the interface region is believed to increase, and a higher induced current is consequently observed for the larger proportion of RIP reactions and negative counter-ions created.

Evidently, despite a larger current and net ion population, the measured positive RIP signal relies on formation in favorable transmission regions. Most curiously, regardless of repeller potential or DART gas flow, the induced current disappears completely with high DART heater temperatures (300-500° C.). Often, but not always, this current loss is accompanied by RIP signal loss close to maximum temperature, which can help explain the occasional reduced DART signal intensity at elevated temperatures. As the corona discharge remains largely uncorrupted at higher temperature, the signal decrease and current loss must be linked to the unsolved nature of the DART mechanism in the present setup. In keeping with the RIP premise, compromised DART signal intensity and current loss at high temperatures may be attributed to: desiccation of the reaction region leading to diminished RIP cluster formation and a new reaction kinetic equilibrium; poor mixing between cool stagnant air and the heated, high flow DART stream; and perturbation of field stability in the reaction region due to changes in air permittivity and conductivity.

In theory, the induced repeller current behavior just described may help corroborate the proposed secondary ion formation mechanism. However, a lack of positive correlation between induced repeller current (and glow) and the reactant ion population intensity is very suspect. In the absence of a measureable electrode current, e.g. high DART temperatures, DART RIP signal can still be present. It may be that the current necessary to produce a saturated RIP is much lower (only nA), beyond the range of the HV supply. In addition, peak intensity does not increase with increasing current. If signal depended significantly on corona-like electron ejection stimulated by DART generated species, one would expect that the RIP should scale proportionately with the induced current, which is not the case. Even for induced repeller currents up to 10× larger than those ever noted for corona discharge alone (only 0.1-0.2 μA), the RIP for DART appears almost spectrally identical and consistently less intense than for corona discharge, which also indicates the DART RIP is not limited by availability of reactant molecules. Despite higher induced currents with a DART discharge on, one can conjecture that many positive secondary ions produced from high energy collision events at the electrode are simply forming in poor field regions that forbid transmission. In the ideal component configurations, perhaps only those emission events initiated at the electrode point result in measurable RIP signal, where the ionization avalanche is effectively propagated in a field region offering favorable ion transport.

The present invention illustrates dominantly field-regulated positive ion transmission for the repeller-assisted DART source as configured. The ancillary observations regarding the repeller electrode do not exclusively substantiate a singular “mechanism” for signal production, nor do they convincingly support signal contribution from secondary ion formation. The influence of the electric field profile is incontrovertible and more explicit from the data.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A sample analyzing system comprising:
an ionization source configured to ionize a sample under ambient pressure, the ionization source having an activated ionization source potential;
an ion detector configured to operate under ambient pressure, the ion detector having an inlet with an activated ion detector inlet potential greater than the activated ionization source potential, the activated ionization source potential and the activated ion detector inlet potential formed when, respectively, the ionization source and the ion detector are activated; and
a repeller positioned at the inlet of the ion detector and biased above the activated ion detector inlet potential to guide at least a portion of the ions from the ionization source into the ion detector.

2. The sample analyzing system of claim 1, wherein the ionization source is a plasma ionization source.

3. The sample analyzing system of claim 1, wherein the ionization source is a direct analysis in real time (DART) ionization source.

4. The sample analyzing system of claim 1, wherein the ionization source is a desorption electrospray ionization (DESI) source.

5. The sample analyzing system of claim 1, wherein the ionization source is a desorption atmospheric pressure photoionization (DAPPI) source.

6. The sample analyzing system of claim 1, wherein the ionization source is an electrospray-assisted laser desorption/ionization (ELDI) source.

7. The sample analyzing system of claim 1, wherein the repeller is an electrode.

8. The sample analyzing system of claim 1, wherein the ionization source is positioned orthogonally to the ion detector inlet, and the repeller is coaxially centered normal to the ion detector inlet.

9. The sample analyzing system of claim 1, wherein the repeller potential is greater than or equal to 1 kV over activated ion detector inlet potential.

10. The sample analyzing system of claim 1, wherein the sample is a solid.

11. The sample analyzing system of claim 1, wherein the sample is a liquid.

12. A sample analyzing system comprising:
an ionization source configured to ionize a sample under ambient pressure, the ionization source having an activated ionization source potential;
an ion detector configured to operate under ambient pressure, the ion detector having an inlet with an activated ion detector inlet potential greater than the activated ionization source potential, the activated ionization source potential and the activated ion detector inlet potential formed when, respectively, the ionization source and the ion detector are activated; and
a repeller positioned at the inlet of the ion detector and biased above the activated ion detector inlet potential to guide at least a portion of the ions from the ionization source into the ion detector;
wherein the ionization source is positioned orthogonally to the ion detector inlet, and the repeller is coaxially centered normal to the ion detector inlet; and
wherein the repeller potential is greater than or equal to 1 kV over activated ion detector inlet potential.

13. The sample analyzing system of claim 12, wherein the ionization source is a plasma ionization source.

14. The sample analyzing system of claim 12, wherein the ionization source is a direct analysis in real time (DART) ionization source.

15. The sample analyzing system of claim 12, wherein the ionization source is a desorption electrospray ionization (DESI) source.

16. The sample analyzing system of claim 12, wherein the ionization source is a desorption atmospheric pressure photoionization (DAPPI) source.

17. The sample analyzing system of claim 12, wherein the ionization source is an electrospray-assisted laser desorption/ionization (ELDI) source.

18. A method of analyzing a sample comprising:
ionizing at least a portion of surface bound species of a sample under ambient pressure;
guiding at least a portion of the ions toward ion detector configured to operate under ambient pressure, the ion detector having an inlet with an activated ion detector inlet potential that must be overcome to enable at least a majority of guided ions to enter the inlet; and
biasing at least a portion of the guided ions into the inlet of the ion detector by providing a biasing potential in proximity of the inlet that is greater than the activated ion detector inlet potential.

19. The method of analyzing a sample according to claim 18 further comprising providing the biasing potential with a repeller electrode.

20. The sample analyzing system of claim 19, wherein the biasing potential is greater than or equal to 1 kV over the activated ion detector inlet potential.
